(19) United States
(12) Patent Application Publication
(10) Pub. No.: US 2017/0081345 A1
(43) Pub. Date: Mar. 23, 2017

(54) METAL-ORGANIC FRAMEWORKS CHARACTERIZED BY HAVING A LARGE NUMBER OF ADSORPTION SITES PER UNIT VOLUME

(71) Applicant: The Regents of the University of California, Oakland, CA (US)

(72) Inventors: Omar M. Yaghi, Berkeley, CA (US); Felipe Gandara, Albany, CA (US); Seungkyu Lee, Oakland, CA (US)

(21) Appl. No.: 15/126,395

(22) PCT Filed: Mar. 17, 2015
(86) PCT No.: PCT/US2015/021107

§ 371 Date: Sep. 15, 2016

Related U.S. Application Data
(60) Provisional application No. 61/955,001, filed on Mar. 18, 2014.

(51) Int. Cl. C07F 5/06; C10L 3/06; F17C 11/00; B01J 20/22

(52) U.S. Cl. CPC C07F 5/069; B01J 20/226; B01J 20/22; C10L 3/06; F17C 11/007; F17C 2221/033; F17C 2270/0168

(57) ABSTRACT

The disclosure provides for metal organic frameworks characterized by having a high number of linking moieties connected to metal clusters and a large number of adsorption sites per unit volume. The disclosure further provides for the use of these frameworks for gas separation, gas storage, catalysis, and drug delivery.

### CROSS REFERENCE TO RELATED APPLICATIONS

This application claims priority under 35 U.S.C. §119 from Provisional Application Ser. No. 61/955,001, filed Mar. 18, 2014, the disclosure of which is incorporated herein by reference.

### TECHNICAL FIELD

The disclosure provides for metal organic frameworks characterized by having a high number of linking moieties connected to metal clusters. Accordingly, the MOFs of the disclosure have an exceptionally large number of adsorption sites per unit volume. The disclosure further provides for the use of these frameworks for gas separation, gas storage, catalysis, and drug delivery.

### BACKGROUND

Metal-organic frameworks (MOFs) are porous crystalline nano-materials that are constructed by linking metal clusters called Secondary Building Units (SBUs) and organic linking moieties. MOFs have high surface area and high porosity which enable them to be utilized in diverse fields, such as gas storage, catalysis, and sensors.

### SUMMARY

The use of porous materials to store natural gas in vehicles requires large amounts of methane per unit of volume. The disclosure provides for metal organic frameworks (MOFs) comprising a plurality of metal clusters connected together by organic linking ligands to form porous two or three dimensional highly ordered structures. The MOFs of the disclosure in comparison to other MOFs known in the art are characterized by having an unusually high number of linking moieties connected to metal clusters (SBUs), thereby providing a large number of adsorption sites per unit volume. The MOFs disclosed herein exhibit exceptional gas storage and gas separation properties for energy related gases, such as hydrogen and methane.

In certain embodiments provided herein is the syntheses, crystal structure and methane adsorption properties of three innovative aluminum-based MOFs: MOF-519, MOF-520 and MOF-521. The materials exhibit permanent porosity and high methane volumetric storage capacity. MOF-519 has a volumetric capacity of 200 and 279 cm³ cm⁻³ at 298 K and 35 and 80 bar, respectively, and MOF-520 has a volumetric capacity of 162 and 231 cm³ cm⁻³ under the same conditions. Furthermore, MOF-519 exhibits an exceptional working capacity, being able to deliver a large amount of methane at pressures between 5 and 35 bar, 151 cm³ cm⁻³, and between 5 and 80 bar, 230 cm³ cm⁻³.

In a certain embodiment, the disclosure provides for a metal-organic framework (MOF) which comprises a plurality of linked M-O-L Secondary Building Units (SBUs), wherein M is a metal, metal ion, or metal containing complex; O is an oxygen atom of a carboxylate based linking cluster; and L is an organic linking ligand comprising one or more structures of any one of Formula I-V:

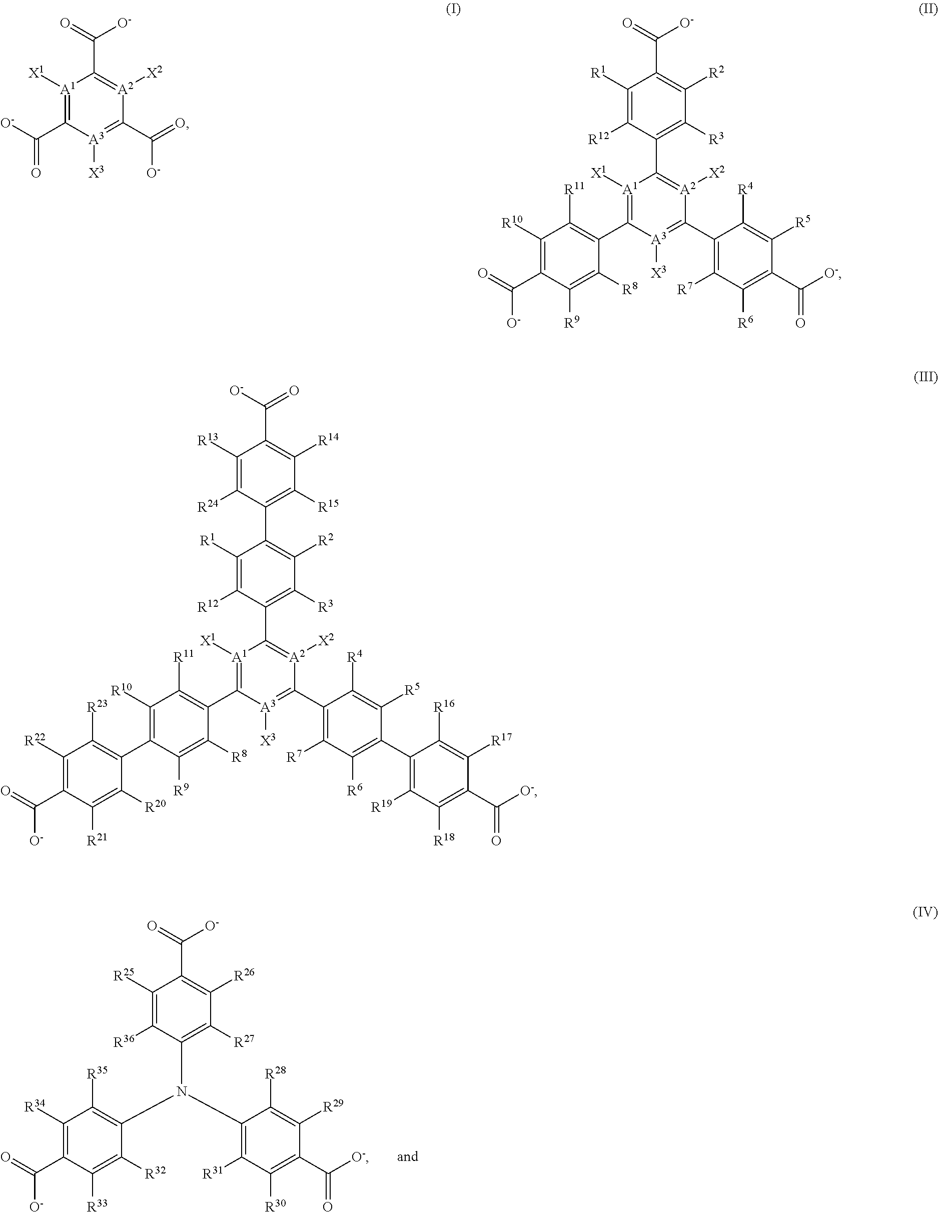

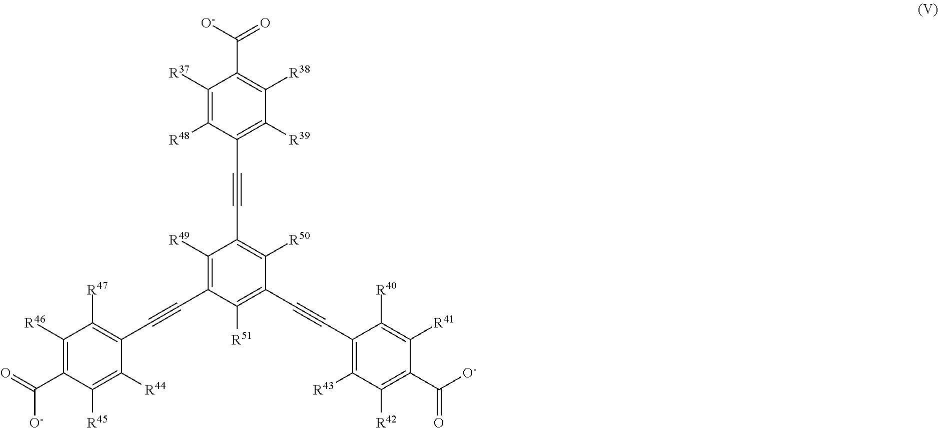

wherein, A¹-A³ are independently a C, N, O, or S; X¹-X³ are independently selected from H, D, functional group (“FG”), optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more optionally substituted rings selected from cycloalkyl, cycloalkenyl, heterocycle, aryl, and mixed ring system; and R¹-R⁵¹ are independently selected from H, D, FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more optionally substituted rings selected from the group comprising cycloalkyl, cycloalkenyl, heterocycle, aryl, and mixed ring system; wherein the SBUs of the MOF optionally comprises one or more pendant linkers and/or one or more modulators; and wherein the MOF is characterized by having a large number of adsorption sites per unit of volume. In a further embodiment, a MOF disclosed herein comprises a plurality of linked M-O-L Secondary Building Units (SBUs), wherein M is a metal, metal ion, or metal containing complex; O is an oxygen atom of a carboxylate based linking cluster; and L is an organic linking ligand comprising one or more structures of any one of Formula I-V:

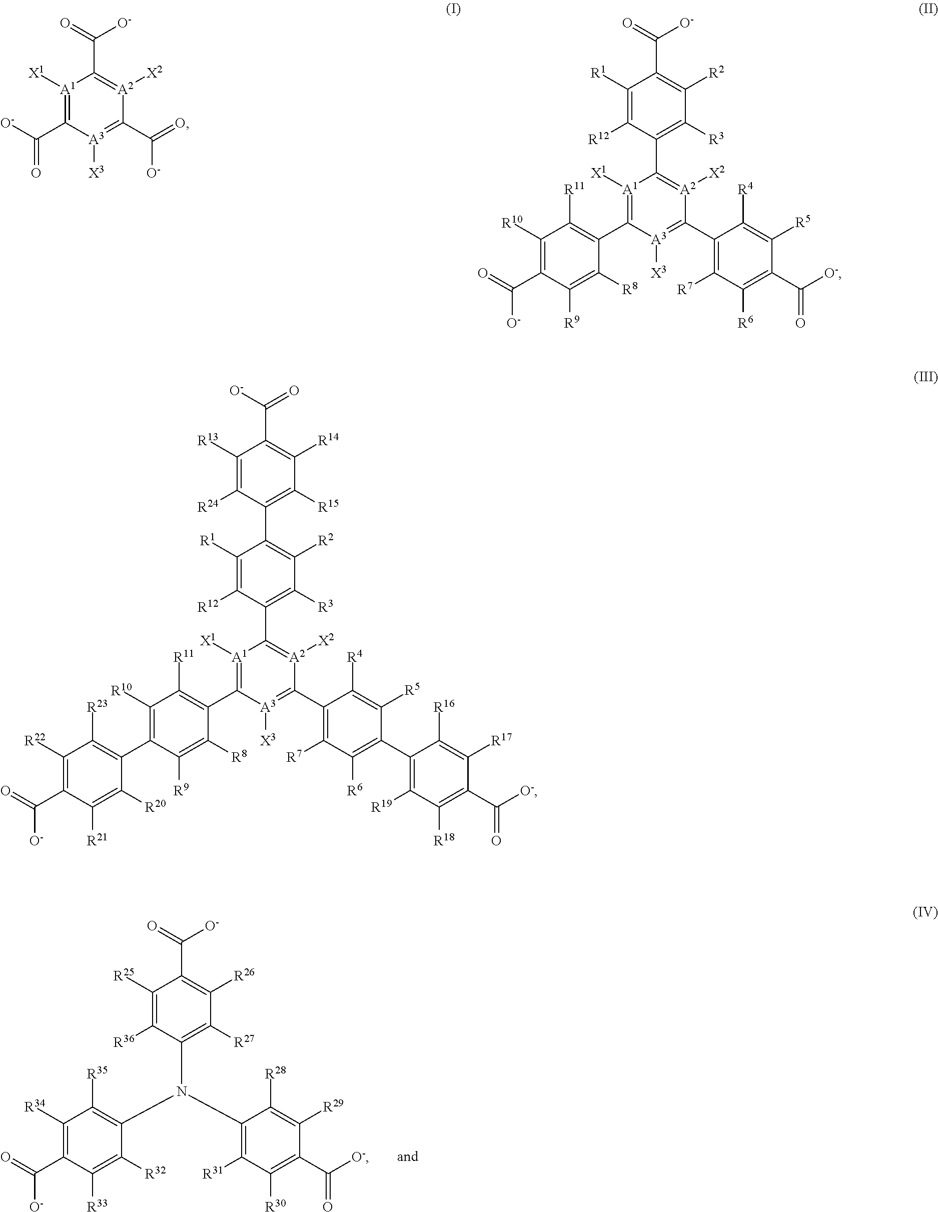

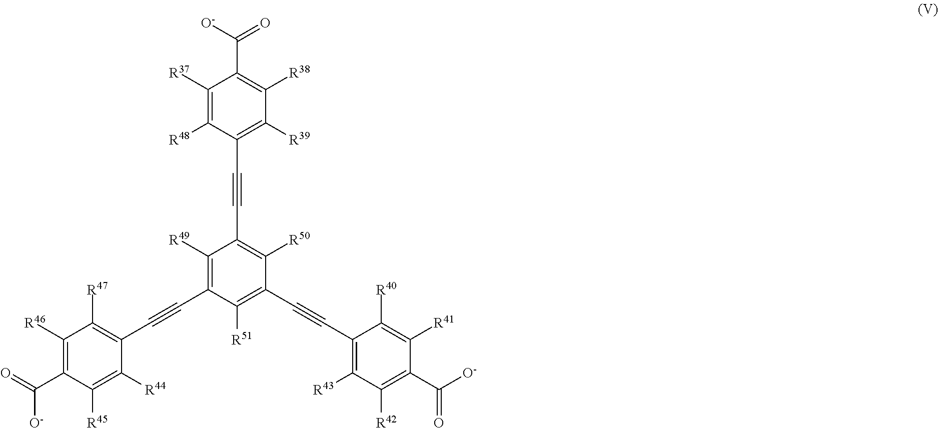

wherein, A¹-A³ are independently a C or N; X¹-X³ are independently selected from H, D, FG, optionally substituted (C₁-C₆)alkyl, optionally substituted (C₁-C₆)heteroalkyl, optionally substituted (C₁-C₆)alkenyl, optionally substituted (C₁-C₆)heteroalkenyl, optionally substituted (C₁-C₆)alkynyl, optionally substituted (C₁-C₆)heteroalkynyl, optionally substituted (C₁-C₆)cycloalkyl, optionally substituted (C₁-C₆)cycloalkenyl, optionally substituted aryl, optionally substituted heterocycle, optionally substituted mixed ring system, wherein one or more adjacent R groups can be linked together to form one or more optionally substituted rings selected from the group comprising cycloalkyl, cycloalkenyl, heterocycle, aryl, and mixed ring system; R¹, R³-R⁵, R⁷-R⁹, R¹¹-R¹³, R⁵-R⁷, R⁹-R²¹, R²³-R²⁵, R²⁷-R²⁹, R³¹-R³³, R³⁵-R³⁶, R³⁷, R³⁹-R⁴¹, R⁴³-R⁴⁵, and R⁴⁷-R⁵¹ are H; and R², R⁶, R¹⁰, R¹⁴, R¹⁸, R²², R²⁶, R³⁰, R³⁴, R³⁸, R⁴², and R⁴⁶ are independently selected from amine, methyl, hydroxyl, ═O, ═S, halo, optionally substituted aryl, optionally substituted aryloxy, alkoxy, —O—(CH₂)ₙ—CH₃, and —O—(CH₂)₂—O—CH₂—CH₃, wherein n is an integer from 1 to 5; wherein the SBUs of the MOF optionally comprises one or more pendant linkers and/or one or more modulators; and wherein the MOF is characterized by having a large number of adsorption sites per unit of volume. In yet a further embodiment, A MOF disclosed herein comprises a plurality of linked M-O-L Secondary Building Units (SBUs), wherein M is a metal, metal ion, or metal containing complex; O is an oxygen atom of a carboxylate based linking cluster; and L is an organic linking ligand comprising one or more structures of any one of Formula

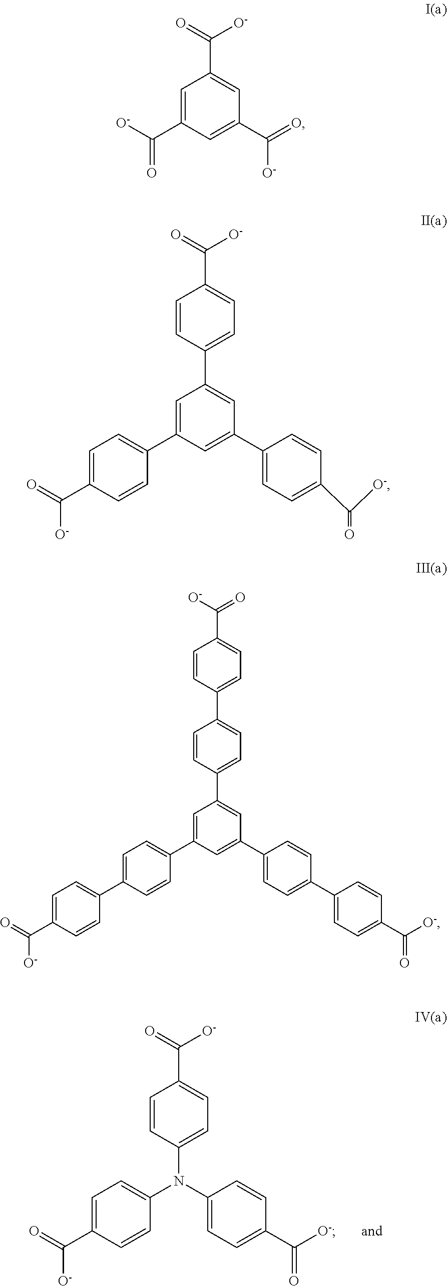

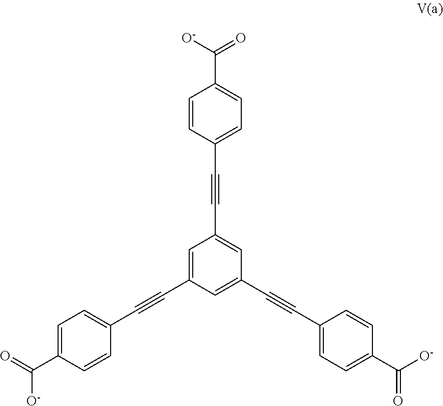 [SMILES: O=C([O-])c1ccc(C#Cc2cc(C#Cc3ccc(C(=O)[O-])cc3)cc(C#Cc3ccc(C(=O)[O-])cc3)c2)cc1]

wherein the SBUs of the MOF optionally comprises one or more pendant linkers and/or one or more modulators; and wherein the MOF is characterized by having a large number of adsorption sites per unit of volume. In another embodiment, the MOF disclosed herein comprises a plurality of linked M-O-L Secondary Building Units (SBUs), wherein M is a metal, metal ion, or metal containing complex; O is an oxygen atom of a carboxylate based linking cluster; and L is an organic linking ligand comprising a structure of Formula II(a):

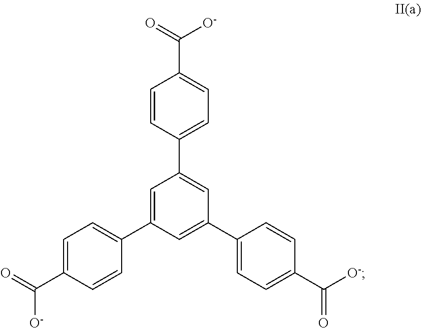

and wherein the SBUs of the MOF optionally comprises one or more pendant linkers and/or one or more modulators; and wherein the MOF is characterized by having a large number of adsorption sites per unit of volume.

In a particular embodiment, the disclosure provides that for a MOF disclosed herein each SBU comprises at least 8 metal or metal ions coordinated to a plurality of organic linking ligands. In a further embodiment, the disclosure provides that for a MOF disclosed herein each SBU comprises octahedrally coordinated metal or metal ions that are cornered joined by doubly bridging OH groups. In yet a further embodiment, each SBU of the MOF disclosed herein has a ring-shaped motif. In another embodiment, the disclosure provides that for a MOF disclosed herein each SBU comprises 10 to 16 organic linking ligands coordinated to a plurality of metal or the metal ions.

In a certain embodiment, a MOF disclosed herein comprises a metal or metal ion selected from: Li⁺, Na⁺, K⁺, Rb⁺, Cs⁺, Be²⁺, Mg²⁺, Ca²⁺, Sr²⁺, Ba²⁺, Sc³⁺, Sc²⁺, Sc⁺, Y³⁺, Y²⁺, Y⁺, Ti⁴⁺, Ti³⁺, Ti²⁺, Zr⁴⁺, Zr³⁺, Zr²⁺, Hf⁴⁺, Hf³⁺, V⁵⁺, V⁴⁺, V³⁺, V²⁺, Nb⁵⁺, Nb⁴⁺, Nb³⁺, Nb²⁺, Ta⁵⁺, Ta⁴⁺, Ta³⁺, Ta²⁺, Cr⁶⁺, Cr⁵⁺, Cr⁴⁺, Cr³⁺, Cr²⁺, Cr⁺, Cr, Mo⁶⁺, Mo⁵⁺, Mo⁴⁺, Mo³⁺, Mo²⁺, Mo⁺, Mo, W⁶⁺, W⁵⁺, W⁴⁺, W³⁺, W²⁺, W⁺, W, Mn⁷⁺, Mn⁶⁺, Mn⁵⁺, Mn⁴⁺, Mn³⁺, Mn²⁺, Mn⁺, Re⁷⁺, Re⁶⁺, Re⁵⁺, Re⁴⁺, Re³⁺, Re²⁺, Re⁺, Re, Fe⁶⁺, Fe⁴⁺, Fe³⁺, Fe²⁺, Fe⁺, Fe, Ru⁸⁺, Ru⁷⁺, Ru⁶⁺, Ru⁴⁺, Ru³⁺, Ru²⁺, Os⁸⁺, Os⁷⁺, Os⁶⁺, Os⁵⁺, Os⁴⁺, Os³⁺, Os²⁺, OS⁺, Os, Co⁵⁺, Co⁴⁺, Co³⁺, Co²⁺, Co⁺, Rh⁶⁺, Rh⁵⁺, Rh⁴⁺, Rh³⁺, Rh²⁺, Rh⁺, Ir⁶⁺, Ir⁵⁺, Ir⁴⁺, Ir³⁺, Ir²⁺, Ir⁺, Ir, Ni³⁺, Ni²⁺, Ni⁺, Ni, Pd⁶⁺, Pd⁴⁺, Pd²⁺, Pd⁺, Pd, Pt⁶⁺, Pt⁵⁺, Pt⁴⁺, Pt³⁺, Pt²⁺, Pt⁺, Cu⁴⁺, Cu³⁺, Cu²⁺, Cu⁺, Ag³⁺, Ag²⁺, Ag⁺, Au⁵⁺, Au⁴⁺, Au³⁺, Au²⁺, Au⁺, Zn²⁺, Zn⁺, Zn, Cd²⁺, Cd⁺, Hg⁴⁺, Hg²⁺, Hg⁺, B³⁺, B²⁺, B⁺, Al³⁺, Al²⁺, Al⁺, Ga³⁺, Ga²⁺, Ga⁺, In³⁺, In²⁺, In⁺, Tl³⁺, Tl⁺, Si⁴⁺, Si³⁺, Si²⁺, Si⁺, Ge⁴⁺, Ge³⁺, Ge²⁺, Ge⁺, Ge, Sn⁴⁺, Sn²⁺, Pb⁴⁺, Pb²⁺, As⁵⁺, As³⁺, As²⁺, As⁺, Sb⁵⁺, Sb³⁺, Bi⁵⁺, Bi³⁺, Te⁶⁺, Te⁵⁺, Te⁴⁺, Te²⁺, La³⁺, La²⁺, Ce⁴⁺, Ce³⁺, Ce²⁺, Pr⁴⁺, Pr³⁺, Pr²⁺, Nd³⁺, Nd²⁺, Sm³⁺, Sm²⁺, Eu³⁺, Eu²⁺, Gd³⁺, Gd²⁺, Gd⁺, Tb⁴⁺, Tb³⁺, Tb²⁺, Tb⁺, Db³⁺, Db²⁺, Ho³⁺, Er³⁺, Tm⁴⁺, Tm³⁺, Tm²⁺, Yb³⁺, Yb²⁺, Lu³⁺, La³⁺, La²⁺, La⁺, and combinations thereof, including any complexes which contain the metal ions listed, as well as any corresponding metal salt counter-anions. In further embodiment, a MOF disclosed herein comprises a metal or metal ion selected from: Ti⁴⁺, Ti³⁺, Ti²⁺, Cr⁶⁺, Cr⁵⁺, Cr⁴⁺, Cr³⁺, Cr²⁺, Cr⁺, Al³⁺, Al²⁺, or Al⁺, including any complexes which contain the metal ions listed, as well as any corresponding metal salt counter-anions. In yet a further embodiment, a MOF disclosed herein comprises a metal or metal ion selected from: Al³⁺, Al²⁺, or Al⁺, including any complexes which contain the metal ions listed, as well as any corresponding metal salt counter-anions.

In a particular embodiment, the disclosure provides that a MOF disclosed herein comprises four pendant linkers. In a further embodiment, the four pendant linkers have the same structure as the organic linking moiety. In yet a further embodiment, the disclosure provides for a MOF which comprises Al₈(OH)₈(BTB)₄(H₂BTB)₄ (MOF-519).

In a certain embodiment, the disclosure provides that a MOF disclosed herein comprises one of more modulators that have a structure selected from: formate, acetate, propionate, butyrate, pentanate, hexanate, lactate, oxalate, citrate, pivalate, carboxylate anions of amino acids,

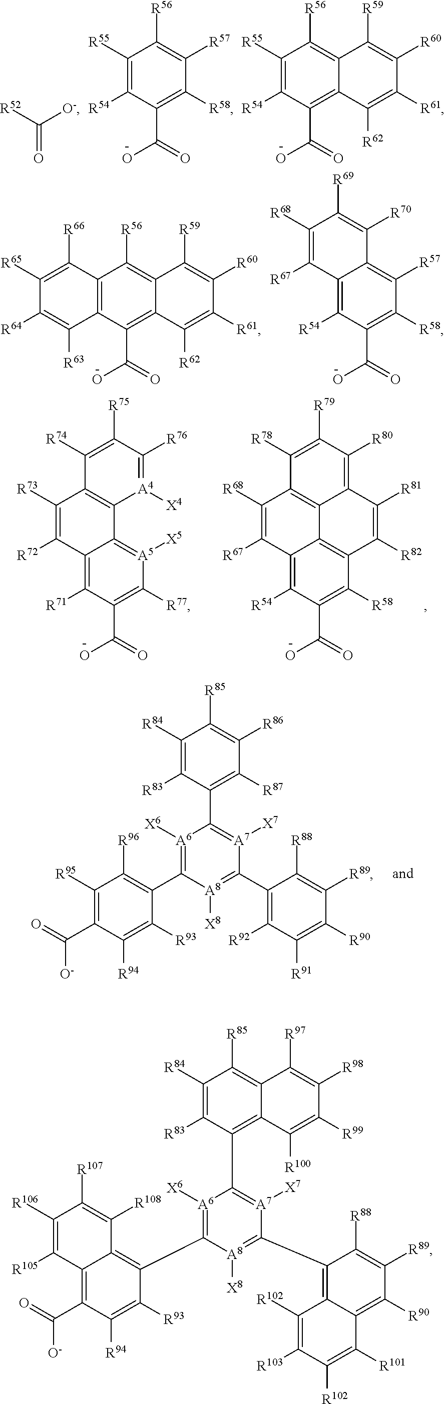

wherein, A⁴-A⁸ are independently a C, N, O, or S; X⁴-X⁸ are independently selected from H, D, optionally substituted FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more substituted rings selected from the group comprising cycloalkyl, cycloalkenyl, heterocycle, aryl, and mixed ring system; and R⁵² and R⁵⁴-R¹⁰⁸ are independently selected from H, D, optionally substituted FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉) cycloalkenyl, optionally substituted aryl, optionally substituted heterocycle, optionally substituted mixed ring system, wherein one or more adjacent R groups can be linked together to form one or more substituted rings selected from the group comprising cycloalkyl, cycloalkenyl, heterocycle, aryl, and mixed ring system. In a further embodiment, a MOF disclosed herein comprises four modulators, wherein the modulators are selected from formate, acetate, and pivalate. In another embodiment, the disclosure provides for a MOF which comprises Al₈(OH)₈(BTB)₄(HCOO)₄ (MOF-520).

In a certain embodiment, the disclosure provides that MOF disclosed herein comprises SBUs that further comprise one or more bound organic molecules or metal clusters. In another embodiment, the MOF disclosed herein has a methane working capacity of at least 190 cm³ cm⁻³ at 80 bar. In yet another embodiment, the MOF disclosed herein has a methane working capacity of at least 230 cm³ cm⁻³ at 80 bar.

In a particular embodiment, the disclosure provides a gas storage or a gas separation device which comprises a MOF disclosed herein. In another embodiment, the gas storage device is fuel storage tank. In a further embodiment, the fuel storage tank is methane storage tank or a clean natural gas (CNG) tank. In yet a further embodiment, the methane storage tank or the CNG tank is dimensioned and configured to be used in a vehicle.

In a certain embodiment, the disclosure provides a method to separate and/or store one or more gases comprising contacting the one or more gases with a MOF disclosed herein. In a further embodiment, the one or more gases comprise natural gas. In an alternate embodiment, the one or more gases comprise methane.

### DESCRIPTION OF DRAWINGS

FIG. 1 presents a scheme demonstrating the requisite methane gas fuel tank characteristics for the automobile industry. Working capacity is defined as the usable amount of methane that results from subtracting the uptake at the operational desorption pressure (5 bar) from the uptake at the maximum adsorption operational pressure. For materials with large total uptake, the working capacity might be substantially reduced if a large amount of methane cannot be desorbed at the operational desorption pressure remaining unutilized in the fuel tank.

FIG. 2 presents a table showing the total methane uptake and working capacity (Desorption at 5 bar) for various MOFs at 35, 80, and 250 bar and 298 K. The table demonstrates that the MOFs of the disclosure had superior methane storage capacity in comparison to other materials.

FIG. 3A-F presents an overview of the reactions to make MOF-519 and MOF-520 and the structural characteristics of the resulting structures. MOF-519 and MOF-520 are built from (A) octametallic inorganic SBUs and the (B) organic 1,3,5-Tris(4-carboxyphenyl)benzene (BTB) linker. In MOF-519, (C) part of the framework void space is occupied by dangling BTB ligands, which are represented in medium grey (the framework linkers are represented in light gray). There are four of these ligands in each SBU (E). In MOF-520 (D) formate ligands replace the extra BTB ligands in the SBU (F), resulting larger pores. Aluminum atoms are represented as polyhedra, oxygen atoms as small grey spheres, and carbon atoms as black spheres. Hydrogen atoms are omitted for clarity. Large gray spheres represent the accessible pore space in the framework.

FIG. 4 presents a close-up view of a polyhedral representation of the secondary building unit (SBU) of MOF-519. The SBU chemical formula is Al₈(OH)₈(CO₂)₁₆. Aluminum atoms are represented as polyhedra, oxygen atoms as grey spheres, and carbon atoms as black spheres. Hydrogen atoms are omitted for clarity.

FIG. 5 presents a comparison of calculated and experimental powder diffraction patterns from a single crystal of MOF-519.

FIG. 6 presents a polyhedral representation of MOF-519. The large gray spheres represent the accessible pore space in the framework, with a diameter of 7.6 Å. Aluminum atoms are represented as polyhedra, oxygen atoms as gray spheres, and carbon atoms as light gray spheres. Hydrogen atoms are omitted for clarity.

FIG. 7 presents a thermogravimetric analysis (TGA) curve of MOF-519 under nitrogen flow.

FIG. 8 provides a hydrogen isotherm of MOF-519 collected at 298 K (diamonds) and 7K (squares).

FIG. 9 provides a carbon dioxide isotherm of MOF-519 collected at 295 K. Squares represent the excess uptake, diamonds represent the total uptake

FIG. 10 provides a methane isotherm of MOF-519 collected at 298 K. Squares represent the excess uptake, diamonds represent the total uptake.

FIG. 11 provides excess methane isotherms of MOF-519 for sample batch 2, at 273, 283, and 298 K, respectively.

FIG. 12 provides an excess methane isotherm of MOF-519 batch 1 at 298 K. A low-pressure isotherm was overlaid for comparison.

FIG. 13 provides excess methane isotherms of MOF-519 measured at 298 K, where materials were prepared independently but under the same procedure.

FIG. 14 provides excess methane isotherms of sample batch 2 of MOF-519 measured at 273 K, 283 K, and 298 K.

FIG. 15 provides a representation of the crystal structure of MOF-520 from various views, where carbon atoms are black spheres, oxygen atoms are grey spheres, and aluminum atoms are polyhedra. MOF-520 crystallizes in the tetragonal space group P4₂2₁2, with units cell parameters a=18.878(4) Å, c=37.043(8) Å.

FIG. 16 provides a representation of the Secondary Building Units (SBUs) of MOF-520. A SBU is coordinated by 4 formate ions and 12 carboxyl groups from BTB linkers.

FIG. 17 provides a variation of the MOF-520 structure where insertion of various organic molecules or metal clusters into the middle of the SBU is possible. As shown, two acetone molecules have been inserted in the middle of the SBU and the carbonyl group of acetone binds to the middle of the ring.

FIG. 18 provides a representation of the SBU of MOF-520 where hydroxyl ions bridging Al metals are indicated. The hydroxyl ions can be substituted by other ions, such as formates, alkoxy ions, and organic molecules containing carboxylate group(s).

FIG. 19 provides a comparison of the experimental powder diffraction pattern of MOF-520 with the one calculated from the single crystal structure.

FIG. 20 provides thermogravimetric (TGA) curve of MOF-520 under nitrogen flow.

FIG. 21 provides TGA data for MOF-520 treated with acetone so that the framework only contains 10% formate ions. The MOF-520 framework was found to decompose at 580° C.

FIG. 22 provides a nitrogen isotherm of MOF-520. S_{Langmuir}=3930 m²/g.

FIG. 23 provides excess methane isotherms of MOF-520 measured at 273 K, 283 K, and 298 K.

FIG. 24 provides excess methane isotherm of MOF-520 at 298 K. The low-pressure isotherm was overlaid for comparison.

FIG. 25 provides a comparison of nitrogen isotherms at 77 K of two sample batches of MOF-519 with MOF-520.

FIG. 26 provides a comparison of the isosteric heats of adsorption (Qst) for methane in MOF-519 and MOF-520 calculated from fits of their 273, 283, and 298 K isotherms.

FIG. 27 provides total methane isotherm of sample batch 1 of MOF-519 (circles) at 298 K and calculated isotherm from the dual site Langmuir model (line). Bulk density of methane is overlaid (broken curve).

FIG. 28 provides total methane isotherm of sample batch 1 of MOF-520 (circles) at 298 K and calculated isotherm from the dual site Langmuir model (line). Bulk density of methane is overlaid (broken curve).

FIG. 29 provides total methane isotherm of sample batch 1 of MOF-5 (circles) at 298 K and calculated isotherm from the dual site Langmuir model (line). Bulk density of methane is overlaid (broken curve).

FIG. 30 provides total methane isotherm of sample batch 1 of MOF-177 (circles) at 298 K and calculated isotherm from the dual site Langmuir model (line). Bulk density of methane is overlaid (broken curve).

FIG. 31 provides total methane isotherm of sample batch 1 of MOF-205 (circles) at 298 K and calculated isotherm from the dual site Langmuir model (line). Bulk density of methane is overlaid (broken curve).

FIG. 32 provides total methane isotherm of sample batch 1 of MOF-210 (circles) at 298 K and calculated isotherm from the dual site Langmuir model (line). Bulk density of methane is overlaid (broken curve).

FIG. 33 provides a comparison of the working capacity for MOF-519, MOF-520, the top performing MOFs, and the porous carbon AX-21. Values are calculated as the difference between the uptake at 35 bar or 80 bar and the uptake at 5 bar. As a reference, the working capacity for bulk methane data are overlaid. Data for MOF-177, MOF-5, MOF-205, and MOF-210 were obtained from Furukawa et al. (“Ultrahigh Porosity in Metal-Organic Frameworks,” Science 329(5990):424-428 (2010)), and data for HKUST-1, PCN-24, Ni-MOF-74, and AX-21 were obtained from Mason et al. (“Evaluating Metal-Organic Frameworks for Natural Gas Storage,” Chem. Sci. 5:32-51 (2014)).

FIG. 34 demonstrates that MOF-519 and MOF-520 show high total methane volumetric uptake. For comparison, bulk density of methane is represented as broken curve. Filled markers represent adsorption points, and empty markers represent desorption points.

FIG. 35 indicates that by exchanging the MOF-520 formate ions with methoxy ions results in SBU reconfiguration and structure distortion.

FIG. 36 indicates that by exchanging the MOF-520 formate ions with methoxy ions results in the width of the channel being widen and the height of the channel being narrowed. This is a single crystal to singe crystal transition. The solvent accessible surface area and pore sizes are indicated.

FIG. 37 demonstrates a scheme for functionalizing MOF-520 with naphthalenemonocarboxylic acid (NMC).

FIG. 38 provides a representation of the crystal structure of MOF-521 [Al(OH)₃(HCOO)₃BTB] from different views where carbon atoms are black spheres, oxygen atoms are gray spheres, and aluminum atoms are polyhedra. MOF-521 crystallizes in the hexagon space group P31c, with unit cell parameters a=21.915 Å, c=6.607 Å.

FIG. 39 provides detailed views of MOF-521 looking at SBU and BTB cores from two angles.

### DETAILED DESCRIPTION

As used herein and in the appended claims, the singular forms “a,” “and,” and “the” include plural referents unless the context clearly dictates otherwise. Thus, for example, reference to “an organic linking ligand” includes a plurality of such linking ligands and reference to “the metal ion” includes reference to one or more metal ions and equivalents thereof known to those skilled in the art, and so forth.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

All publications mentioned throughout the disclosure are incorporated herein by reference in full for the purpose of describing and disclosing the methodologies, which are described in the publications, which might be used in connection with the description herein. The publications discussed above and throughout the text are provided solely for their disclosure prior to the filing date of the present application. Nothing herein is to be construed as an admission that the inventors are not entitled to antedate such disclosure by virtue of prior disclosure. Moreover, with respect to similar or identical terms found in the incorporated references and terms expressly defined in this disclosure, the term definitions provided in this disclosure will control in all respects.

Unless defined otherwise, all technical and scientific terms used herein have the same meaning as commonly understood to one of ordinary skill in the art. Although there are many methods and reagents similar or equivalent to those described herein, the exemplary methods and materials are presented herein.

As used herein, a wavy line intersecting another line that is connected to an atom indicates that this atom is covalently bonded to another entity that is present but not being depicted in the structure. A wavy line that does not intersect a line but is connected to an atom indicates that this atom is interacting with another atom by a bond or some other type of identifiable association.

A bond indicated by a straight line and a dashed line indicates a bond that may be a single covalent bond or alternatively a double covalent bond. But in the case where an atom's maximum valence would be exceeded by forming a double covalent bond, then the bond would be a single covalent bond.

Unless defined otherwise, all technical and scientific terms used herein have the same meaning as commonly understood to one of ordinary skill in the art. Although there are many methods and reagents similar or equivalent to those described herein, the exemplary methods and materials are presented herein.

The term “alkenyl”, refers to an organic group that is comprised of carbon and hydrogen atoms that contains at least one double covalent bond between two carbons. Typically, an “alkenyl” as used in this disclosure, refers to organic group that contains 1 to 30 carbon atoms, unless stated otherwise. While a C₁-alkenyl can form a double bond to a carbon of a parent chain, an alkenyl group of three or more carbons can contain more than one double bond. It certain instances the alkenyl group will be conjugated, in other cases an alkenyl group will not be conjugated, and yet other cases the alkenyl group may have stretches of conjugation and stretches of nonconjugation. Additionally, if there is more than 1 carbon, the carbons may be connected in a linear manner, or alternatively if there are more than 3 carbons then the carbons may also be linked in a branched fashion so that the parent chain contains one or more secondary, tertiary, or quaternary carbons. An alkenyl may be substituted or unsubstituted, unless stated otherwise.

The term “alkyl”, refers to an organic group that is comprised of carbon and hydrogen atoms that contain single covalent bonds between carbons. Typically, an “alkyl” as used in this disclosure, refers to an organic group that contains 1 to 30 carbon atoms, unless stated otherwise. Where if there is more than 1 carbon, the carbons may be connected in a linear manner, or alternatively if there are more than 2 carbons then the carbons may also be linked in a branched fashion so that the parent chain contains one or more secondary, tertiary, or quaternary carbons. An alkyl may be substituted or unsubstituted, unless stated otherwise.

The term “alkynyl”, refers to an organic group that is comprised of carbon and hydrogen atoms that contains a triple covalent bond between two carbons. Typically, an “alkynyl” as used in this disclosure, refers to organic group that contains 1 to 30 carbon atoms, unless stated otherwise. While a C₁-alkynyl can form a triple bond to a carbon of a parent chain, an alkynyl group of three or more carbons can contain more than one triple bond. Where if there is more than 1 carbon, the carbons may be connected in a linear manner, or alternatively if there are more than 4 carbons then the carbons may also be linked in a branched fashion so that the parent chain contains one or more secondary, tertiary, or quaternary carbons. An alkynyl may be substituted or unsubstituted, unless stated otherwise.

The term “aryl”, as used in this disclosure, refers to a conjugated planar ring system with delocalized pi electron clouds that contain only carbon as ring atoms. An “aryl” for the purposes of this disclosure encompass from 1 to 12 aryl rings wherein when the aryl is greater than 1 ring the aryl rings are joined so that they are linked, fused, or a combination thereof. An aryl may be substituted or unsubstituted, or in the case of more than one aryl ring, one or more rings may be unsubstituted, one or more rings may be substituted, or a combination thereof.

The term “cylcloalkenyl”, as used in this disclosure, refers to an alkene that contains at least 3 carbon atoms but no more than 12 carbon atoms connected so that it forms a ring. A “cycloalkenyl” for the purposes of this disclosure encompass from 1 to 12 cycloalkenyl rings, wherein when the cycloalkenyl is greater than 1 ring, then the cycloalkenyl rings are joined so that they are linked, fused, or a combination thereof. A cycloalkenyl may be substituted or unsubstituted, or in the case of more than one cycloalkenyl ring, one or more rings may be unsubstituted, one or more rings may be substituted, or a combination thereof.

The term “cylcloalkyl”, as used in this disclosure, refers to an alkyl that contains at least 3 carbon atoms but no more than 12 carbon atoms connected so that it forms a ring. A “cycloalkyl” for the purposes of this disclosure encompass from 1 to 12 cycloalkyl rings, wherein when the cycloalkyl is greater than 1 ring, then the cycloalkyl rings are joined so that they are linked, fused, or a combination thereof. A cycloalkyl may be substituted or unsubstituted, or in the case of more than one cycloalkyl ring, one or more rings may be unsubstituted, one or more rings may be substituted, or a combination thereof.

The term “framework” as used herein, refers to a highly ordered structure comprised of secondary building units (SBUs) that can be linked together in defined, repeated and controllable manner, such that the resulting structure is characterized as being porous, periodic and crystalline. Typically, “frameworks” are two dimensional (2D) or three dimensional (3D) structures. Examples of “frameworks” include, but are not limited to, “metal-organic frameworks” or “MOFs”, “zeolitic imidazolate frameworks” or “ZIFs”, or “covalent organic frameworks” or “COFs”. While MOFs and ZIFs comprise SBUs of metals or metal ions linked together by forming covalent bonds with linking clusters on organic linking moieties, COFs are comprised of SBUs of organic linking moieties that are linked together by forming covalent bonds via linking clusters. As used herein, “framework” does not refer to coordination complexes or metal complexes. Coordination complexes or metal complexes are comprised of a relatively few number of centrally coordinated metal ions (e.g., less than 4 central ions) that are coordinately bonded to molecules or ions, also known as ligands or complexing agents. By contrast, “frameworks” are highly ordered and extended structures that are not based upon a centrally coordinated ion, but involve many repeated secondary building units (SBUs) linked together. Accordingly, “frameworks” are orders of magnitude much larger than coordination complexes and have different structural and chemical properties due to the framework's open and ordered structure.

The term “functional group” or “FG” refers to specific groups of atoms within molecules that are responsible for the characteristic chemical reactions of those molecules. While the same functional group will undergo the same or similar chemical reaction(s) regardless of the size of the molecule it is a part of, its relative reactivity can be modified by nearby functional groups. The atoms of functional groups are linked to each other and to the rest of the molecule by covalent bonds. Examples of FG that can be used in this disclosure, include, but are not limited to, substituted or unsubstituted alkyls, substituted or unsubstituted alkenyls, substituted or unsubstituted alkynyls, substituted or unsubstituted aryls, substituted or unsubstituted hetero-alkyls, substituted or unsubstituted hetero-alkenyls, substituted or unsubstituted hetero-alkynyls, substituted or unsubstituted cycloalkyls, substituted or unsubstituted cycloalkenyls, substituted or unsubstituted hetero-aryls, substituted or unsubstituted heterocycles, halos, hydroxyls, anhydrides, carbonyls, carboxyls, carbonates, carboxylates, aldehydes, haloformyls, esters, hydroperoxy, peroxy, ethers, orthoesters, carboxamides, amines, imines, imides, azides, azos, cyanates, isocyanates, nitrates, nitriles, isonitriles, nitrosos, nitros, nitrosooxy, pyridyls, sulfhydryls, sulfides, disulfides, sulfinyls, sulfos, thiocyanates, isothiocyanates, carbonothioyls, phosphinos, phosphonos, phosphates, Si(OH)₃, Ge(OH)₃, Sn(OH)₃, Si(SH)₄, Ge(SH)₄, AsO₃H, AsO₄H, P(SH)₃, As(SH)₃, SO₃H, Si(OH)₃, Ge(OH)₃, Sn(OH)₃, Si(SH)₄, Ge(SH)₄, Sn(SH)₄, AsO₃H, AsO₄H, P(SH)₃, and As(SH)₃.

The term “hetero-” when used as a prefix, such as, hetero-alkyl, hetero-alkenyl, hetero-alkynyl, or hetero-hydrocarbon, for the purpose of this disclosure refers to the specified hydrocarbon having one or more carbon atoms replaced by non-carbon atoms as part of the parent chain. Examples of such non-carbon atoms include, but are not limited to, N, O, S, Si, Al, B, and P. If there is more than one non-carbon atom in the hetero-based parent chain then this atom may be the same element or may be a combination of different elements, such as N and O.

The term “heterocycle”, as used in this disclosure, refers to ring structures that contain at least 1 noncarbon ring atom. A “heterocycle” for the purposes of this disclosure encompass from 1 to 12 heterocycle rings wherein when the heterocycle is greater than 1 ring the heterocycle rings are joined so that they are linked, fused, or a combination thereof. A heterocycle may be a hetero-aryl or nonaromatic, or in the case of more than one heterocycle ring, one or more rings may be nonaromatic, one or more rings may be hetero-aryls, or a combination thereof. A heterocycle may be substituted or unsubstituted, or in the case of more than one heterocycle ring one or more rings may be unsubstituted, one or more rings may be substituted, or a combination thereof. Typically, the noncarbon ring atom is N, O, S, Si, Al, B, or P. In case where there is more than one noncarbon ring atom, these noncarbon ring atoms can either be the same element, or combination of different elements, such as N and O. Examples of heterocycles include, but are not limited to: a monocyclic heterocycle such as, aziridine, oxirane, thiirane, azetidine, oxetane, thietane, pyrrolidine, pyrroline, imidazolidine, pyrazolidine, pyrazoline, dioxolane, sulfolane 2,3-dihydrofuran, 2,5-dihydrofuran tetrahydrofuran, thiophane, piperidine, 1,2,3,6-tetrahydro-pyridine, piperazine, morpholine, thiomorpholine, pyran, thiopyran, 2,3-dihydropyran, tetrahydropyran, 1,4-dihydropyridine, 1,4-dioxane, 1,3-dioxane, dioxane, homopiperidine, 2,3,4,7-tetrahydro-1H-azepine homopiperazine, 1,3-dioxepane, 4,7-dihydro-1,3-dioxepin, and hexamethylene oxide; and polycyclic heterocycles such as, indole, indoline, isoindoline, quinoline, tetrahydroquinoline, isoquinoline, tetrahydroisoquinoline, 1,4-benzodioxan, coumarin, dihydrocoumarin, benzofuran, 2,3-dihydrobenzofuran, isobenzofuran, chromene, chroman, isochroman, xanthene, phenoxathiin, thianthrene, indolizine, isoindole, indazole, purine, phthalazine, naphthyridine, quinoxaline, quinazoline, cinnoline, pteridine, phenanthridine, perimidine, phenanthroline, phenazine, phenothiazine, phenoxazine, 1,2-benzisoxazole, benzothiophene, benzoxazole, benzthiazole, benzimidazole, benztriazole, thioxanthine, carbazole, carboline, acridine, pyrolizidine, and quinolizidine. In addition to the polycyclic heterocycles described above, heterocycle includes polycyclic heterocycles wherein the ring fusion between two or more rings includes more than one bond common to both rings and more than two atoms common to both rings. Examples of such bridged heterocycles include quinuclidine, diazabicyclo[2.2.1]heptane and 7-oxabicyclo[2.2.1]heptane.

The terms “heterocyclic group”, “heterocyclic moiety”, “heterocyclic”, or “heterocyclo” used alone or as a suffix or prefix, refers to a heterocycle that has had one or more hydrogens removed therefrom.

The term “hydrocarbons” refers to groups of atoms that contain only carbon and hydrogen. Examples of hydrocarbons that can be used in this disclosure include, but are not limited to, alkanes, alkenes, alkynes, arenes, and benzyls.

The term “linking cluster” refers to one or more atoms capable of forming an association, e.g. covalent bond, polar covalent bond, ionic bond, and Van Der Waal interactions, with one or more atoms of another linking moiety, and/or one or more metal or metal ions. A linking cluster can be part of the parent chain itself, e.g. a heteroatom, and/or additionally can arise from functionalizing the parent chain, e.g. adding carboxylic acid groups to the linking moiety's parent chain. For example, a linking cluster can comprise —NN(H)N, —N(H)NN, —CO₂H, —CS₂H, —NO₂, —SO₃H, —Si(OH)₃, —Ge(OH)₃, —Sn(OH)₃, —Si(SH)₄, —Ge(SH)₄, —Sn(SH)₄, —PO₃H, —AsO₃H, —AsO₄H, —P(SH)₃, —As(SH)₃, —CH(RSH)₂, —C(RSH)₃, —CH(RNH₂)₂, —C(RNH₂)₃, —CH(ROH)₂, —C(ROH)₃, —CH(RCN)₂, —C(RCN)₃, —CH(SH)₂, —C(SH)₃, —CH(NH₂)₂, —C(NH₂)₃, —CH(OH)₂, —C(OH)₃, —CH(CN)₂, and —C(CN)₃, wherein R is an alkyl group having from 1 to 5 carbon atoms, or an aryl group comprising 1 to 2 phenyl rings and —CH(SH)₂, —C(SH)₃, —CH(NH₂)₂, —C(NH₂)₃, —CH(OH)₂, —C(OH)₃, —CH(CN)₂, and —C(CN)₃. Generally, for a metal-organic framework disclosed herein, the linking cluster(s) that bind one or metal or metal ions are carboxylic acid groups. For a linking cluster that is depicted in a non-de-protonated form (e.g., a carboxylic acid group), the de-protonated form should also be presumed to be included (e.g., carboxylate), unless stated otherwise. For example, although the structural Formulas presented herein are illustrated as having carboxylate-based linking clusters, for the purposes of this disclosure, the illustrated structures should be interpreted as including both the carboxylic acid group and the carboxylate group.

The term “mixed ring system” refers to optionally substituted ring structures that contain at least two rings, and wherein the rings are joined together by linking, fusing, or a combination thereof. A mixed ring system comprises a combination of different ring types, including cycloalkyl, cycloalkenyl, aryl, and heterocycle.

The term “modulator” as used herein, refers to an organic compound that has a single carboxylic acid/carboxylate-based linking cluster. Therefore, in contrast to a pendant ligand or organic linking moiety, a “modulator” as used herein, is not capable of binding a plurality of metal or metal ions from multiple SBUs. A “modulator” can therefore only bind metal or metal ions from a single SBU.

The term “organic linking moiety” or “organic linking ligand” as used herein, refers to a parent chain comprising an alkyl, alkenyl, cycloalkyl, cycloalkenyl, aryl, heterocycle or any combination of the foregoing, which is capable of binding a metal or metal ion or a plurality of metals or metal ions via a linking cluster(s). The parent chain of the linking moiety may be further substituted with one or more functional groups. Further, by reacting the linking moiety with one or more post-framework reactants, the linking moiety may be further modified post framework synthesis. A linking moiety will have at least two linking clusters, preferably three linking clusters. Therefore, a linking moiety is capable of and generally binds to a plurality of metals or metal ions from different SBUs thereby linking the SBUs together to form a “framework.” Examples of “organic linking moieties” include, but are not limited to, the tritopic organic linking ligands designated as Formulae I-V in this disclosure.

The term “pendant ligand” as used herein, refers to an organic linking moiety which is capable of binding a plurality of metal or metal ions from different SBUs via its linking clusters, but has only bound to a metal or metal ions from a single SBU. Therefore, a “pendant ligand” is characterized as not linking multiple SBUs together.

The term “substituent” refers to an atom or group of atoms substituted in place of a hydrogen atom. For purposes of this disclosure, a substituent would include deuterium atoms.

The term “substituted” with respect to hydrocarbons, heterocycles, and the like, refers to structures wherein the parent chain contains one or more substituents.

The term “unsubstituted” with respect to hydrocarbons, heterocycles, and the like, refers to structures wherein the parent chain contains no substituents.

As used herein, a wavy line intersecting another line that is connected to an atom indicates that this atom is covalently bonded to another entity that is present but not being depicted in the structure. A wavy line that does not intersect a line but is connected to an atom indicates that this atom is interacting with another atom by a bond or some other type of identifiable association.

Methane is the main component of natural gas an represents about two-thirds of the fossil fuels on earth, yet it remains the least utilized fuel. Currently there is a great interest in expanding the use of methane for fueling automobiles because of its wide availability and its lower carbon emission compared to petroleum. A current challenge for the implementation of this technology is to find materials that are able to store and deliver large amounts of methane near room temperature and at low pressures. The U.S. Department of Energy (DOE) has initiated a research program aimed at operating methane storage fueling systems at room temperature and desirable pressures of 35 and 80 bar, and as high as 250 bar, pressures relevant to commercially and widely available equipment.

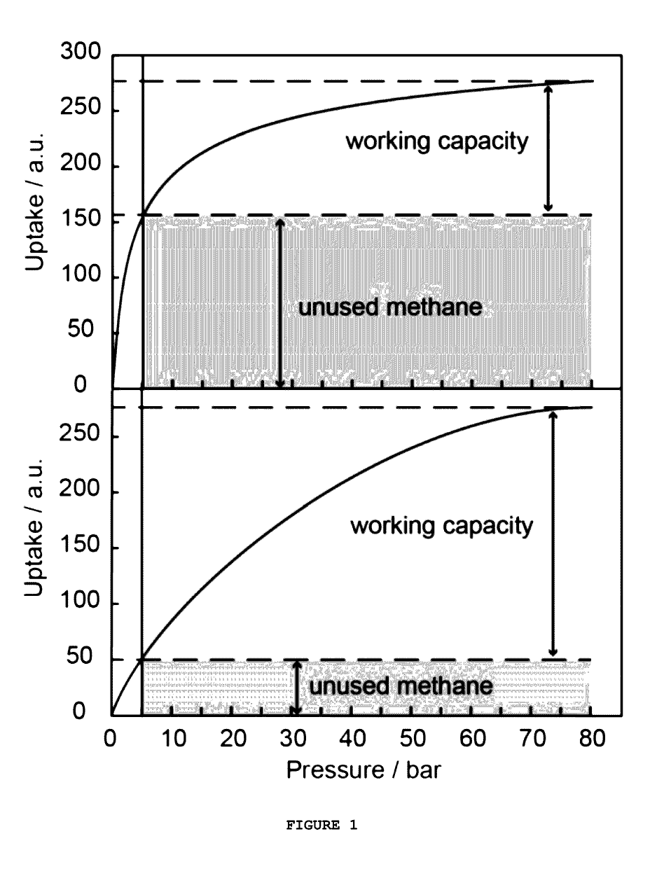

Metal-organic frameworks (MOFs) are porous crystalline materials that are constructed by linking coordinated metal clusters called Secondary Building Units (SBUs) with organic linking moieties. MOFs have high surface areas and high porosity which enable them to be utilized in diverse fields, such as gas storage, catalysis, and sensors. Discovered 15 years ago, more than 37,241 MOFs have been made so far. However, due to pore dynamics, the adsorbent capabilities of the vast majority of these MOFs are suboptimal for methane and/or hydrogen sorption. Among the many MOFs studied for methane storage, HKUST-1, Ni-MOF-74, MOF-5, MOF-177, MOF-205, MOF-210, and PCN-14 stand out as having some of the highest total volumetric storage capacities. Currently, the automobile industry requires that 5 bar of methane remain unused in the fuel tank, a parameter termed working capacity (illustrated in FIG. 1). Accordingly, determining the working capacity of the MOF for reversible methane storage is one of the keys in evaluating its applicability for such an application. At present, the copper(II)-based MOF HKUST-1 was found to have the highest working capacities for methane by a MOF. HKUST-1 had working capacities of 153 and 200 cm³ cm⁻³, at 35 and 80 bar, respectively. Extensive work, however, is ongoing to find materials whose working capacities exceed HKUST-1.

The disclosure provides for MOFs that have an exceptional capacity for adsorbing energy related gases, such as methane and hydrogen. The MOFs of the disclosure are characterized by having an unusually high number adsorption sites per unit of volume. Moreover, by choice of linking moiety and/or modulator, MOFs can be generated that have pore sizes that are optimal for energy related gases. For example, a MOF of the disclosure, MOF-519 was found to have exceptional working capacity for methane. While most MOFs exhibit a high gravimetric capacity for the adsorption of gases due to their low density, their applicability is limited by their lower volumetric capacity. The disclosure provides for MOFs which overcome low volumetric capacity by comprising SBUs that have an unusually high number of connected linking moieties (e.g., 16), and by having linking moieties that are connected to only one SBU (i.e., pendant linkers). These pendant linkers occupy empty pores. Accordingly, the MOFs disclosed herein comprise unique structural elements which provide a larger number of adsorption sites per unit of volume than other MOFs known in the art.

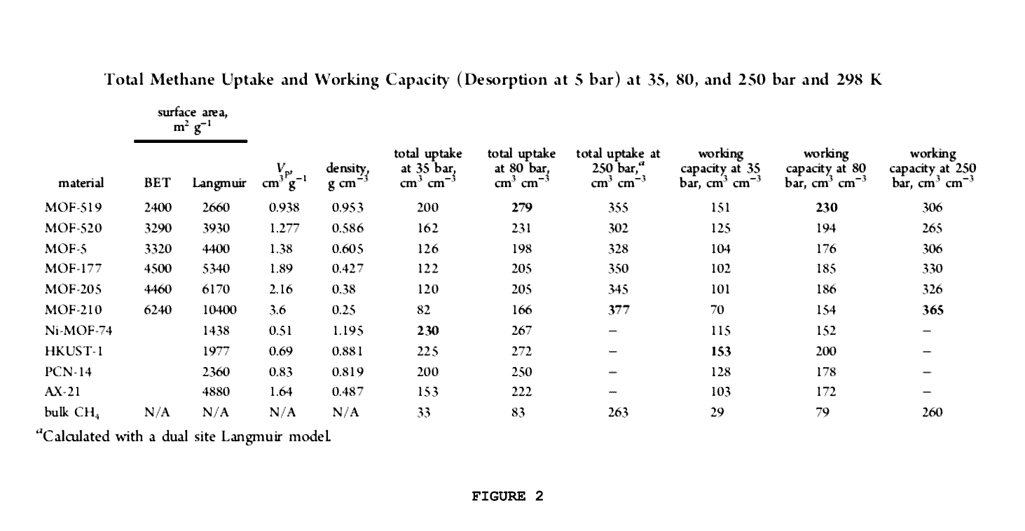

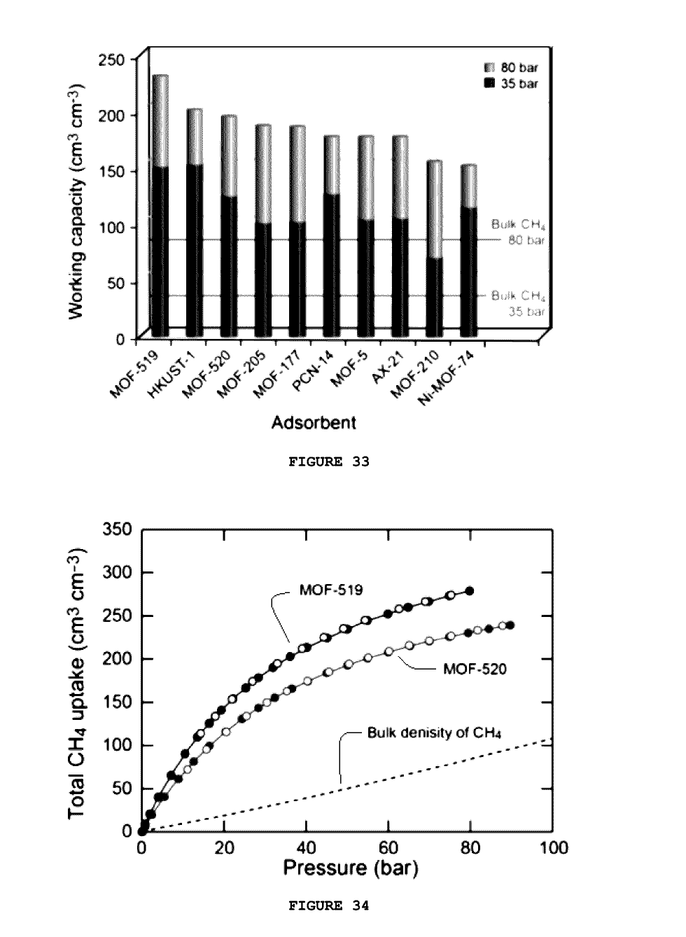

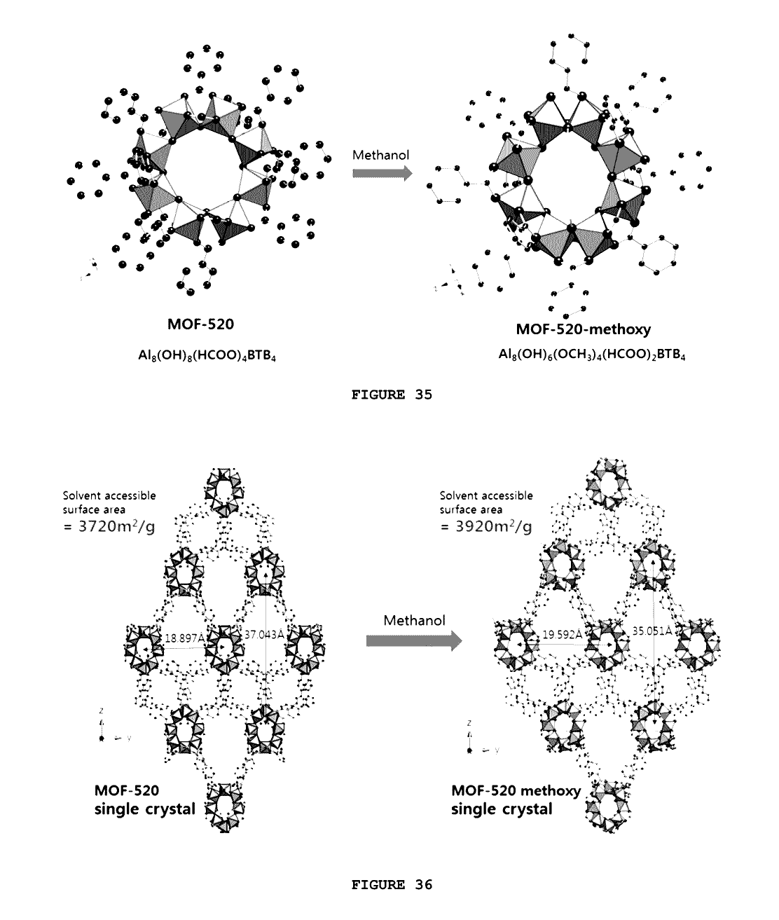

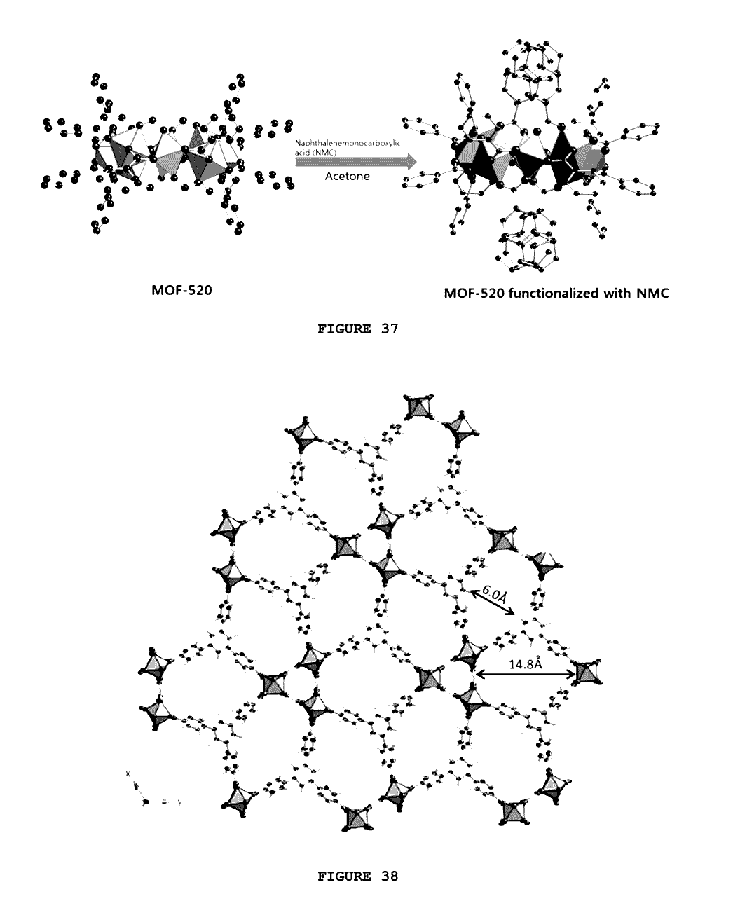

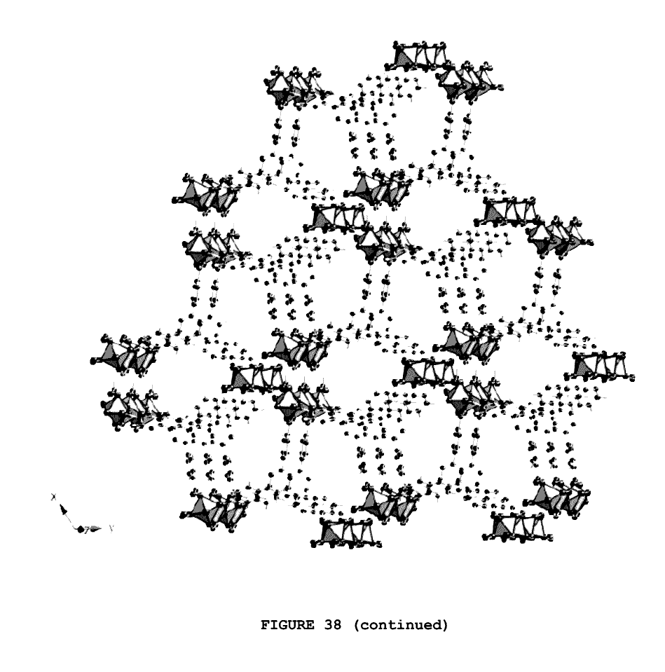

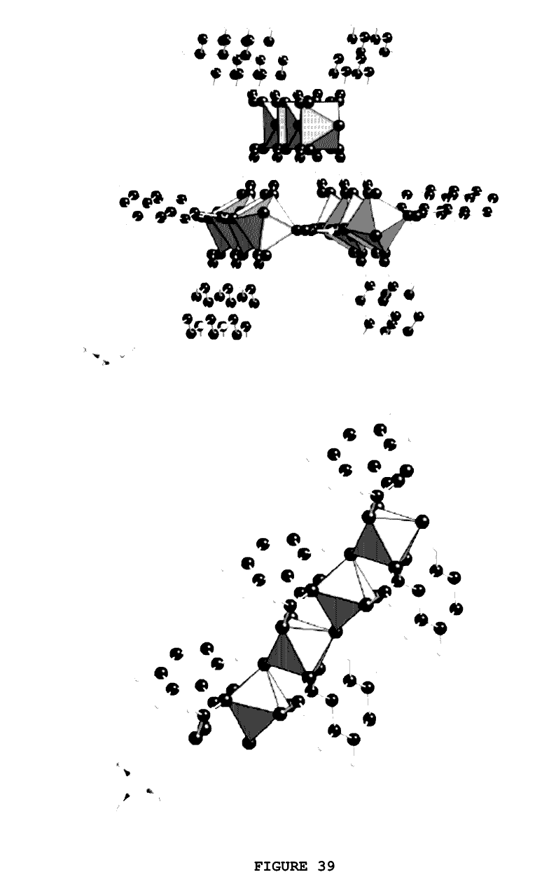

Disclosed herein is the synthesis and characterization of MOFs that have exceptional methane adsorption properties. The MOFs of the disclosure have working capacities at least as good as HKUST-1 and generally exhibit values which exceed the current top performing MOFs under these conditions (see FIG. 2 and FIG. 33). In particular embodiment, the MOFs of the disclosure have a Langmuir surface area of at least 2000 m² g⁻¹, at least 2500 m² g⁻¹, at least 2750 m² g⁻¹, at least 3000 m² g⁻¹, or at least 3100 m² g⁻¹, at least 3200 m² g⁻¹, at least 3300 m² g⁻¹, at least 3400 m² g⁻¹, at least 3500 m² g⁻¹, or at least 4000 m² g⁻¹. In another embodiment, the MOFs of the disclosure have a Langmuir surface area between 2000 m² g⁻¹ to 4000 m² g⁻¹. In a certain embodiment, the MOFs of the disclosure comprises a plurality of pores having a size between 5 Å to 40 Å, 5 Å to 37 Å, 5 Å to 35 Å, 5 Å to 30 Å, 5 Å to 25 Å, 5 Å to 20 Å, 5 Å to 15 Å, or 5 Å to 10 Å. In another embodiment, the MOFs of the disclosure have a working capacity of at least 170 cm³ cm⁻³, at least 180 cm³ cm⁻³, at least 190 cm³ cm⁻³, at least 200 cm³ cm⁻³, at least 210 cm³ cm⁻³, at least 220 cm³ cm⁻³, at least 230 cm³ cm⁻³ or at least 240 cm³ cm⁻³ at ambient temperature and 80 bar. In yet another embodiment, the MOFs of the disclosure have a working capacity between 190 cm³ cm⁻³ to 240 cm³ cm⁻³ at ambient temperature and 80 bar. In another embodiment, the disclosure provides that there are at least 10, at least 11, at least 12, at least 13, at least 14, at least 15, at least 16 organic linking ligands connected to at least one SBU of a MOF disclosed herein. In yet another embodiment, the disclosure provides that there are 10 to 16 organic linking ligands connected to at least one SBU of a MOF disclosed herein. In a further embodiment, the disclosure provides that there are 12 to 16 organic linking ligands connected to at least one SBU of a MOF disclosed herein.

In a particular embodiment, the disclosure provides for MOFs that have a large number of adsorption sites per unit of volume that comprise a plurality of linked M-O-L Secondary Building Units (SBUs), wherein M is a metal, metal ion, or metal containing complex; O is an oxygen atom of a carboxylate based linking cluster; and L is an organic linking ligand comprising an optionally substituted (C₁-C₂₀) alkyl, optionally substituted (C₁-C₂₀) alkenyl, optionally substituted (C₁-C₂₀) alkynyl, optionally substituted (C₁-C₂₀) hetero-alkyl, optionally substituted (C₁-C₂₀) hetero-alkenyl, optionally substituted (C₁-C₂₀) hetero-alkynyl, optionally substituted (C₃-C₁₂) cycloalkyl, optionally substituted (C₃-C₁₂) cycloalkenyl, optionally substituted aryl, optionally substituted heterocycle or optionally substituted mixed ring system, wherein the linking ligand comprises at least two or more carboxylate linking clusters; wherein the SBUs of the MOF optionally comprises one or more pendant linkers and/or one or more modulators.

In a certain embodiment, the disclosure provides for MOFs that have a large number of adsorption sites per unit of volume which comprise a plurality of linked M-O-L Secondary Building Units (SBUs), wherein M is a metal, metal ion, or metal containing complex; O is an oxygen atom of a carboxylate based linking cluster; and L is a tritopic organic linking ligand comprising one or more structures of Formula I-V:

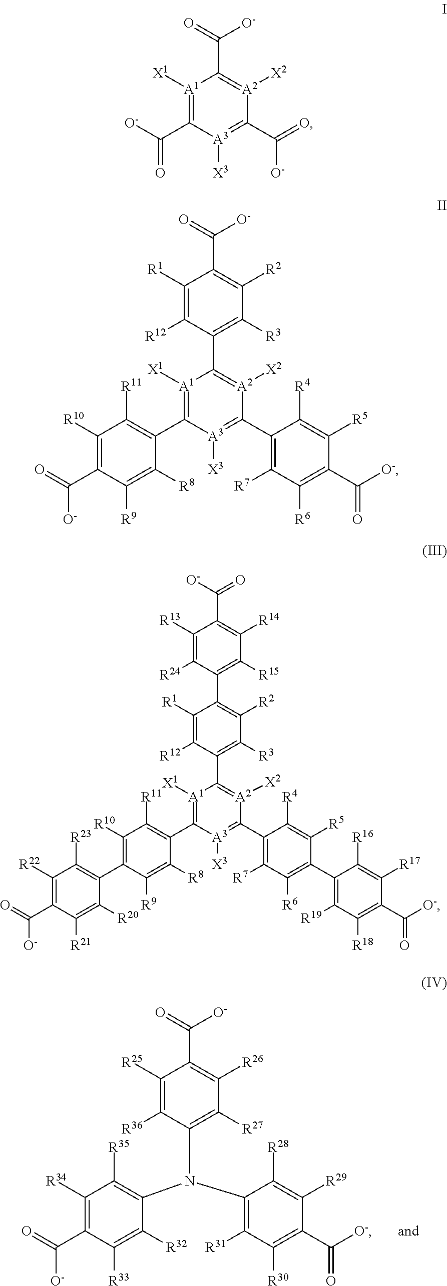

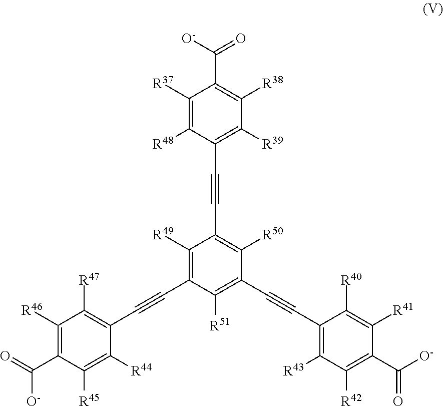

wherein,

A¹-A³ are independently a C, N, O, or S;

X¹-X³ are independently selected from H, D, FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more substituted rings selected from the group comprising cycloalkyl, cycloalkenyl, heterocycle, aryl, and mixed ring system; and

R¹-R⁵¹ are independently selected from H, D, FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more optionally substituted rings selected from cycloalkyl, cycloalkenyl, heterocycle, aryl, and mixed ring system; and

wherein the SBUs of the MOF optionally comprises one or more pendant linkers and/or one or more modulators.

In yet another embodiment, the disclosure provides for MOFs that have a large number of adsorption sites per unit of volume which comprise a plurality of linked M-O-L Secondary Building Units (SBUs), a MOF of the disclosure comprises a plurality of linked M-O-L Secondary Building Units (SBUs), wherein M is a metal, metal ion, or metal containing complex; O is an oxygen atom of a carboxylate based linking cluster; and L is an organic linking ligand comprising one or more structures of any one of Formula I-V:

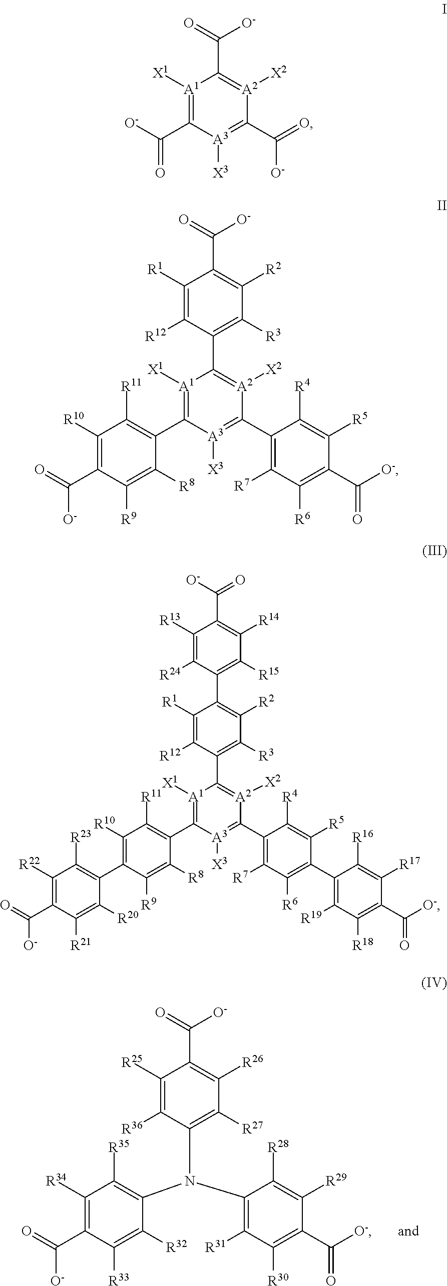

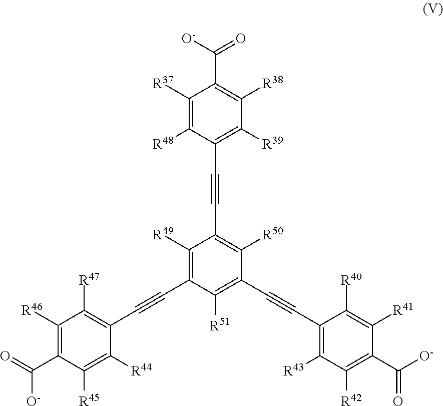

wherein,

A¹-A³ are independently a C or N;

X¹-X³ are independently selected from H, D, FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more substituted rings selected from the group comprising cycloalkyl, cycloalkenyl, heterocycle, aryl, and mixed ring system; and

R¹, R³-R⁵, R⁷-R⁹, R¹¹-R¹³, R¹⁵-R¹⁷, R¹⁹-R²¹, R²³-R²⁵, R²⁷-R²⁹, R³¹-R³³, R³⁵-R³⁶, R³⁷, R³⁹-R⁴¹, R⁴³-R⁴⁵, and R⁴⁷-R⁵¹ are H; and

R², R⁶, R¹⁰, R¹⁴, R¹⁸, R²², R²⁶, R³⁰, R³⁴, R³⁸, R⁴², and R⁴⁶ are independently selected from amino, methyl, hydroxyl, ═O, ═S, halo, optionally substituted aryl, optionally substituted aryloxy, alkoxy, —O—(CH₂)ₙ—CH₃, and —O—(CH₂)₂—O—CH₂—CH₃, wherein n is an integer from 1 to 5; and

wherein the SBUs of the MOF optionally comprises one or more pendant linkers and/or one or more modulators.

In yet another embodiment, the disclosure provides for MOFs that have a large number of adsorption sites per unit of volume which comprise a plurality of linked M-O-L Secondary Building Units (SBUs), a MOF of the disclosure comprises a plurality of linked M-O-L Secondary Building Units (SBUs), wherein M is a metal, metal ion, or metal containing complex; O is an oxygen atom of a carboxylate based linking cluster; and L is an organic linking ligand comprising one or more structures of Formula I(a), II(a), III(a), IV(a), and V(a):

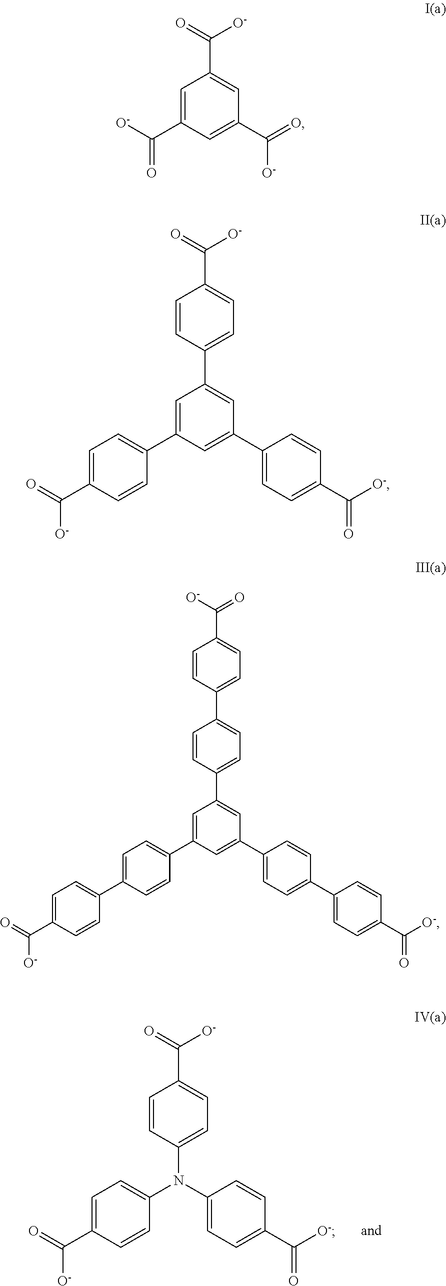

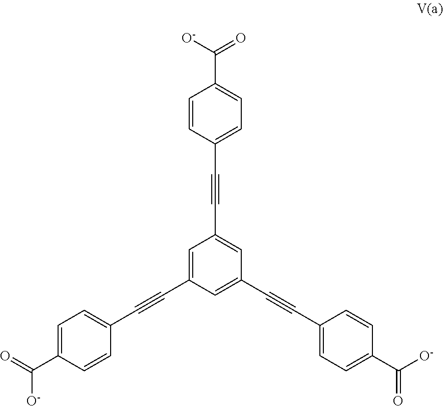 [SMILES: O=C([O-])c1ccc(C#Cc2cc(C#Cc3ccc(C(=O)[O-])cc3)cc(C#Cc3ccc(C(=O)[O-])cc3)c2)cc1]

wherein the SBUs of the MOF optionally comprises one or more pendant linkers and/or one or more modulators.

In yet another embodiment, the disclosure provides for MOFs that have a large number of adsorption sites per unit of volume which comprise a plurality of linked M-O-L Secondary Building Units (SBUs), a MOF of the disclosure comprises a plurality of linked M-O-L Secondary Building Units (SBUs), wherein M is a metal, metal ion, or metal containing complex; O is an oxygen atom of a carboxylate based linking cluster; and L is an organic linking ligand comprising the structure of Formula II(a):

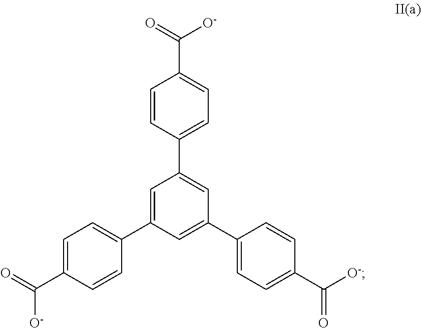

and

wherein the SBUs of the MOF optionally comprises one or more pendant linkers and/or one or more modulators.

In a certain embodiment, one or more metals and/or metal ions, that can be used in the (1) synthesis of a MOF of the disclosure, (2) exchanged post synthesis of a MOF disclosed herein, and/or (3) added to a MOF of the disclosure by forming coordination complexes with post framework reactant linking clusters, include, but are not limited to, Li⁺, Na⁺, K⁺, Rb⁺, Cs⁺, Be²⁺, Mg²⁺, Ca²⁺, Sr²⁺, Ba²⁺, Sc³⁺, Sc²⁺, Sc⁺, Y³⁺, Y²⁺, Y⁺, Ti⁴⁺, Ti³⁺, Ti²⁺, Zr⁴⁺, Zr³⁺, Zr²⁺, Hf⁴⁺, Hf³⁺, V⁵⁺, V⁴⁺, V³⁺, V²⁺, Nb⁵⁺, Nb⁴⁺, Nb³⁺, Nb²⁺, Ta⁵⁺, Ta⁴⁺, Ta³⁺, Ta²⁺, Cr⁶⁺, Cr⁵⁺, Cr⁴⁺, Cr³⁺, Cr²⁺, Cr⁺, Cr, Mo⁶⁺, Mo⁵⁺, Mo⁴⁺, Mo³⁺, Mo²⁺, Mo⁺, Mo, W⁶⁺, W⁵⁺, W⁴⁺, W³⁺, W²⁺, W⁺, W, Mn⁷⁺, Mn⁶⁺, Mn⁵⁺, Mn⁴⁺, Mn³⁺, Mn²⁺, Mn⁺, Re⁷⁺, Re⁶⁺, Re⁵⁺, Re⁴⁺, Re³⁺, Re²⁺, Re⁺, Re, Fe⁶⁺, Fe⁴⁺, Fe³⁺, Fe²⁺, Fe⁺, Fe, Ru⁸⁺, Ru⁷⁺, Ru⁶⁺, Ru⁴⁺, Ru³⁺, Ru²⁺, Os⁸⁺, Os⁷⁺, Os⁶⁺, Os⁵⁺, Os⁴⁺, Os³⁺, Os²⁺, OS⁺, Os, Co⁵⁺, Co⁴⁺, Co³⁺, Co²⁺, Co⁺, Rh⁶⁺, Rh⁵⁺, Rh⁴⁺, Rh³⁺, Rh²⁺, Rh⁺, Ir⁶⁺, Ir⁵⁺, Ir⁴⁺, Ir³⁺, Ir²⁺, Ir⁺, Ir, Ni³⁺, Ni²⁺, Ni⁺, Ni, Pd⁶⁺, Pd⁴⁺, Pd²⁺, Pd⁺, Pd, Pt⁶⁺, Pt⁵⁺, Pt⁴⁺, Pt³⁺, Pt²⁺, Pt⁺, Cu⁴⁺, Cu³⁺, Cu²⁺, Cu⁺, Ag³⁺, Ag²⁺, Ag⁺, Au⁵⁺, Au⁴⁺, Au³⁺, Au²⁺, Au⁺, Zn²⁺, Zn⁺, Zn, Cd²⁺, Cd⁺, Hg⁴⁺, Hg²⁺, Hg⁺, B³⁺, B²⁺, B⁺, Al³⁺, Al²⁺, Al⁺, Ga³⁺, Ga²⁺, Ga⁺, In³⁺, In²⁺, In¹⁺, Tl³⁺, Tl⁺, Si⁴⁺, Si³⁺, Si²⁺, Si⁺, Ge⁴⁺, Ge³⁺, Ge²⁺, Ge⁺, Ge, Sn⁴⁺, Sn²⁺, Pb⁴⁺, Pb²⁺, As⁵⁺, As³⁺, As²⁺, As⁺, Sb⁵⁺, Sb³⁺, Bi⁵⁺, Bi³⁺, Te⁶⁺, Te⁵⁺, Te⁴⁺, Te²⁺, La³⁺, La²⁺, Ce⁴⁺, Ce³⁺, Ce²⁺, Pr⁴⁺, Pr³⁺, Pr²⁺, Nd³⁺, Nd²⁺, Sm³⁺, Sm²⁺, Eu³⁺, Eu²⁺, Gd³⁺, Gd²⁺, Gd⁺, Tb⁴⁺, Tb³⁺, Tb²⁺, Tb⁺, Db³⁺, Db²⁺, Ho³⁺, Er³⁺, Tm⁴⁺, Tm³⁺, Tm²⁺, Yb³⁺, Yb²⁺, Lu³⁺, La³⁺, La²⁺, La⁺, and combinations thereof, including any complexes which contain the metals or metal ions listed above, as well as any corresponding metal salt counter-anions.

In a further embodiment, one or more metals and/or metal ions, that can be used in the (1) synthesis of a MOF of the disclosure, (2) exchanged post synthesis of a MOF disclosed herein, and/or (3) added to a MOF of the disclosure by forming coordination complexes with post framework reactant linking clusters, include, but are not limited to, Ti⁴⁺, Ti³⁺, Ti²⁺, Cr⁶⁺, Cr⁵⁺, Cr⁴⁺, Cr³⁺, Cr²⁺, Cr⁺, Cr, Al³⁺, Al²⁺, Al⁺, and combinations thereof, including any complexes which contain the metal ions listed, as well as any corresponding metal salt counter-anions.

In a particular embodiment, one or more metal ions that can be used in the synthesis of a MOF of the disclosure comprise Al³⁺, Al²⁺, Al⁺ and combinations thereof, including any complexes which contain the metal ions, as well as any corresponding metal salt counter-anions.

In certain embodiments of the disclosure, the metals of the SBU are cornered joined by doubly bridging OH groups. By changing the reaction conditions, e.g., by addition of solvents it would be possible to generate MOFs that are cornered joined by anions other than hydroxide anions. Therefore, in alternate embodiments, the disclosure provides that the metals of the SBU are cornered joined by doubly bridging anions other than hydroxyl groups. In a particular embodiment, the SBUS of the MOF disclosed herein are cornered joined by anions selected from

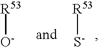

wherein R⁵³ is selected from CN and a (C₁-C₆)alkane.

As demonstrated in certain embodiments herein, the overall framework connectivity can be maintained while incorporating pendant ligands or modulators into the SBUs, e.g., see MOF-519, [Al₈(OH)₈(BTB)₄(H₂BTB)₄] and MOF-520, [Al₈(OH)₈(BTB)₄(HCO₂)₄]. MOF-519 and MOF-520 are constructed using the same tritopic linker benzenetribenzoic acid (H₃BTB) and possess the same SBU type and overall network topology despite MOF-519 comprising pendant ligands and MOF-520 comprising modulators. MOF-520 was prepared in the presence of formic acid, and contains an inorganic SBU with four aluminum-coordinated formate modulators. The formate modulators did not deleteriously impact framework connectivity (e.g., see FIG. 3F). In contrast, these sites are occupied by four additional monocoordinated H₂BTB ligands in MOF-519 (where there is no addition of extra carboxylic acid species in the synthesis) (e.g., see FIG. 3E). The monocoordinated H₂BTB ligands are pendant ligands that dangle into the pores and modulate the sorption properties of the MOF. MOF-519 was shown to have exceptionally high volumetric methane uptake in the Examples presented herein. In a particular embodiment, the pendant linker has the same structure as the organic linking ligand. In an alternate embodiment, the pendant linker has a different structure than the organic linking ligand.

The disclosure provides that the MOFs disclosed herein may optionally comprise pendant ligands. Pendant ligands as defined herein as organic linking ligands which have only bound to the metal or metal ions of a single SBU, although the pendant ligands are capable of binding a plurality of metals or metal ions from multiple SBUs. Therefore, pendant ligands can be thought as organic linking ligands that dangle into pores and are ‘flexible’ By contrast, organic linking ligands that bind multiple SBUs to form the MOF are rigidly fixed in a certain orientation. In a particular embodiment, the pendant ligands have the same structure as the organic linking ligands used to construct the framework. In an alternate embodiment, the pendant ligands do not have the same structure as the organic linking ligands used to construct the framework. Based upon steric and/or electronic considerations, one can choose pendant ligands that preferentially bind certain metals of a SBU. In order to provide SBUs with a ring structure as described in certain embodiments herein, the pendant ligands should generally comprise carboxylic acid based linking clusters.

The MOFs of the disclosure may optionally comprise one or more modulators. Modulators are capable of biding to metals or metal ions of a single SBU. Modulators change the sorption sites and pore size of the resulting MOF. Thus, modulator selection can allow for fine tuning of the interaction strength between a desired gas (e.g., hydrogen, carbon dioxide, and methane) and the MOF. In a particular embodiment, the modulator comprises a carboxylic acid/carboxylate group. Examples of modulators include, but are not limited to, formate, acetate, propionate, butyrate, pentanate, hexanate, lactate, oxalate, citrate, pivalate, carboxylate anions of amino acids,

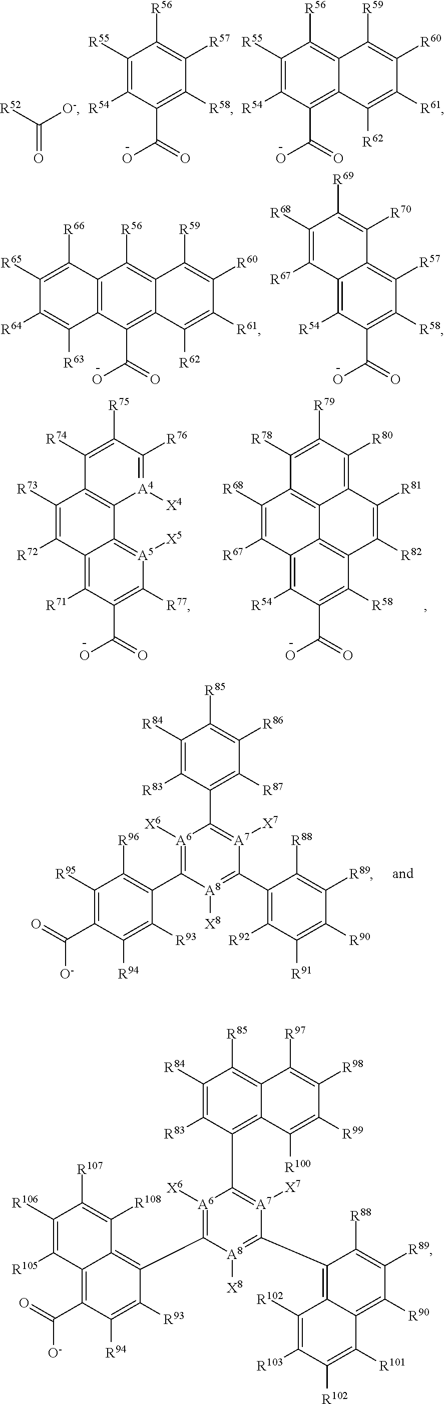

wherein

A⁴-A⁸ are independently a C, N, O, or S;

X⁴-X⁸ are independently selected from H, D, FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more optionally substituted rings selected from the group comprising cycloalkyl, cycloalkenyl, heterocycle, aryl, and mixed ring system; and

R⁵², and R⁵⁴-R¹⁰⁸ are independently selected from H, D, optionally substituted FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more optionally substituted rings selected from the group comprising cycloalkyl, cycloalkenyl, heterocycle, aryl, and mixed ring system. In yet a further embodiment, the disclosure provides for aluminum metal complexes (i.e., aluminum-based SBUs) that are comprised of aluminum metal atoms bridged by hydroxyl, formate, acetate, propionate, butyrate, pentanate, hexanate, lactate, oxalate, citrate, or alkoxy (e.g., methoxy and ethoxy) anions. In a particular embodiment, the modulator comprises the structure of:

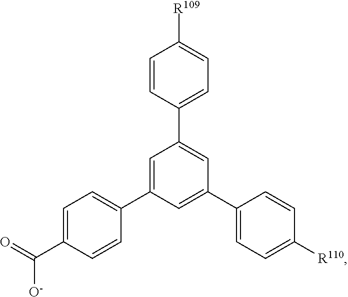

wherein,

R¹⁰⁹ and R¹¹⁰ are independently selected from H, amino, methyl, hydroxyl, ═O, ═S, halo, optionally substituted aryl,

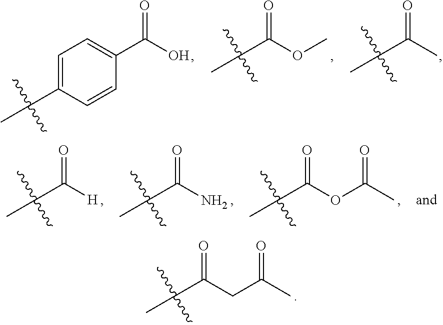

Due to the unique pore dynamics of the MOFs disclosed herein, various organic molecules or metal clusters can be inserted into the middle of the SBUs of the MOFs. For example, the carbonyl group of acetone was found to bind to the middle of the SBU ring for MOF-520. Examples of organic molecules that can be inserted into the SBUs of the MOFs disclosed herein include the following:

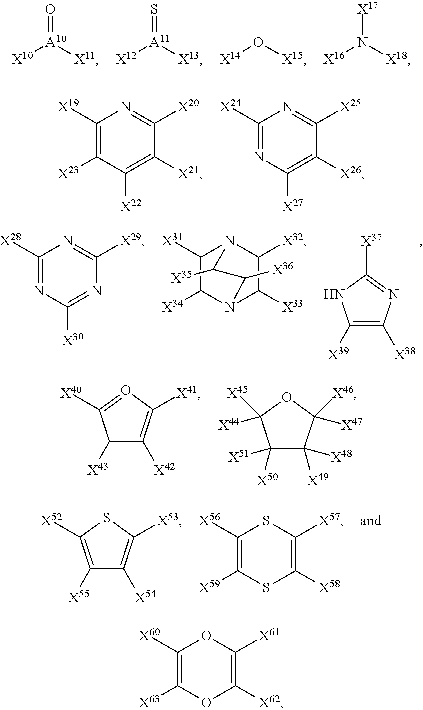

wherein,

A¹⁰ and A¹¹ are independently C or Si;

X¹⁰-X⁶³ are independently selected from H, FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent X groups can be linked together to form one or more optionally substituted rings selected from the group comprising cycloalkyl, cycloalkenyl, heterocycle, aryl, and mixed ring system.

The MOFs of the disclosure may be generated by first utilizing a plurality of linking moieties having different functional groups, wherein at least one of these functional groups may be modified, substituted, or eliminated with a different functional group post-synthesis of the framework. In other words, at least one linking moiety comprises a functional group that may be post-synthesized reacted with a post framework reactant to further increase the diversity of the functional groups of the MOFs disclosed herein. In a certain embodiment, the MOFs as-synthesized are not reacted with a post framework reactant. In another embodiment, the MOFs as-synthesized are reacted with at least one post framework reactant. In yet another embodiment, the MOFs as-synthesized are reacted with at least two post framework reactants. In a further embodiment, the MOFs as-synthesized are reacted with at least one post framework reactant that will result in adding denticity to the framework.

All the aforementioned linking moieties that possess appropriate reactive functionalities can be chemically transformed by a suitable reactant post framework synthesis to add further functionalities to the pores. By modifying the organic links within the framework post-synthetically, access to functional groups that were previously inaccessible or accessible only through great difficulty and/or cost is possible and facile.

In another embodiment, a post framework reactant adds at least one effect to a MOF of the disclosure including, but not limited to, modulating the gas storage ability of the MOF; modulating the sorption properties of the MOF; modulating the pore size of the MOF; modulating the catalytic activity of the MOF; modulating the conductivity of the MOF; and modulating the sensitivity of the MOF to the presence of an analyte of interest. In a further embodiment, a post framework reactant adds at least two effects to the MOF of the disclosure including, but not limited to, modulating the gas storage ability of the MOF; modulating the sorption properties of the MOF; modulating the pore size of the MOF; modulating the catalytic activity of the MOF; modulating the conductivity of the MOF; and modulating the sensitivity of the MOF to the presence of an analyte of interest.

In yet another embodiment, a post framework reactant is selected to modulate the size of the pores of the MOF disclosed herein. In another embodiment, a post framework reactant is selected to increase the hydrophobicity of the MOF disclosed herein. In yet another embodiment, a post framework reactant is selected to modulate gas separation of the MOF disclosed herein. In a certain embodiment, a post framework reactant creates an electric dipole moment on the surface of the MOF of the disclosure when it chelates a metal ion. In a further embodiment, a post framework reactant is selected to modulate the gas sorption properties of the MOF of the disclosure. In another embodiment, a post framework reactant is selected to promote or increase methane sorption of the MOF disclosed herein. In another embodiment, a post framework reactant is selected to promote or increase natural gas sorption of the MOF of the disclosure. In yet a further embodiment, a post framework reactant is selected to increase or add catalytic efficiency to the MOF disclosed herein. In another embodiment, a post framework reactant is selected so that organometallic complexes can be tethered to the MOF of the disclosure. Such tethered organometallic complexes can be used, for example, as heterogeneous catalysts.

In a particular embodiment, the MOFs of the disclosure can be used for catalysis, drug delivery, gas and water adsorption and separation, energy gas storage (e.g., hydrogen, methane and other natural gases), and greenhouse gas capture.

In one embodiment of the disclosure, a gas storage or separation material comprising a MOF of the disclosure is provided. Advantageously, the MOF includes a high number of adsorption sites for storing and/or separating gas molecules. Suitable examples of such gases include, but are not limited to, the gases comprising a component selected from the group consisting of methane, ammonia, argon, carbon dioxide, carbon monoxide, hydrogen, and combinations thereof. In a particularly useful variation the gas storage material is a hydrogen storage material that is used to store hydrogen (H₂). In another particularly useful variation, the gas storage material is a carbon dioxide storage material that may be used to separate carbon dioxide from a gaseous mixture. In yet another particularly useful variation, the gas storage material is a methane storage material that may be used to separate methane from a gaseous mixture.

The disclosure further provides an apparatus and method for separating one or more components from a multi-component gas using a separation system having a feed side and an effluent side separated by a MOF of the disclosure. The apparatus may comprise a column separation format.

In an embodiment of the disclosure, a gas storage material comprising a MOF is provided. Suitable examples of such gases include, but are not limited to, the gases comprising methane ammonia, nitrogen, argon, carbon dioxide, carbon monoxide, hydrogen, and combinations thereof. In particularly useful variation, the MOF is an adsorbent for methane that may be used to separate methane from a natural gas stream. In another particularly useful variation, the gas binding material is a hydrogen gas binding material that may be used to separate hydrogen gas from a mixed gas stream.

“Natural gas” refers to a multi-component gas obtained from a crude oil well (associated gas) or from a subterranean gas-bearing formation (non-associated gas). The composition and pressure of natural gas can vary significantly. A typical natural gas stream contains methane as a significant component. The natural gas will also typically contain ethane, higher molecular weight hydrocarbons, one or more acid gases (such as carbon dioxide, hydrogen sulfide, carbonyl sulfide, carbon disulfide, and mercaptans), and minor amounts of contaminants such as water, nitrogen, iron sulfide, wax, and crude oil. The MOFs of the disclosure can be used as an adsorbent for methane. In a certain embodiment, one or more MOFs disclosed herein can be used to separate and/or store one or more gases from a natural gas stream. In another embodiment, one or more MOFs disclosed herein can be used to separate and/or store methane from a natural gas stream. In yet another embodiment, one or more MOFs disclosed herein can be used to separate and/or store methane from a town gas stream. In yet another embodiment, one or more MOFs disclosed herein can be used to separate and/or store methane from a biogas stream. In a certain embodiment, one or more MOFs disclosed herein can be used to separate and/or store methane from a syngas stream. In an alternate embodiment, one or more MOFs disclosed herein can be used to separate and/or store hexane isomers from a mixed gas stream.

In a particular embodiment, one or more MOFs disclosed herein are part of a device. In another embodiment, a gas separation device comprises one or more MOFs of the disclosure. In a further embodiment, a gas separation device used to separate one or more component gases from a multi-component gas mixture comprises one or more MOFs disclosed herein. Examples of gas separation and/or gas storage devices include, but are not limited to, purifiers, filters, scrubbers, pressure swing adsorption devices, molecular sieves, hollow fiber membranes, ceramic membranes, cryogenic air separation devices, and hybrid gas separation devices. In a certain embodiment, a gas separation device used to separate one or more gases with high electron density from gas mixture comprises one or more MOFs of the disclosure. In a further embodiment, a gas separation device used to separate methane, nitrogen, carbon dioxide, water, or hexane isomers from a mixed gas stream.

In a particular embodiment of the disclosure, a gas storage material comprises one more MOFs disclosed herein. A gas that may be stored or separated by the methods, compositions and systems of the disclosure includes gases such as methane, ammonia, argon, hydrogen sulfide, carbon dioxide, hydrogen sulfide, carbonyl sulfide, carbon disulfide, mercaptans, carbon monoxide, nitrogen, hexane isomers, methane, hydrogen, and combinations thereof. In particularly useful variation, a gas binding material is a methane binding material that may be used to reversibly store methane.

In another embodiment, a gas storage device comprises one or more MOFs disclosed herein. In a particular embodiment, the gas storage device is a clean natural gas (CNG), methane or propane fuel tank. In a further embodiment, the CNG or methane fuel tank is dimensioned and configured to be used with vehicles, such as with passenger cars, trucks, buses, or construction equipment. Examples of CNG or methane tanks include cylinders comprised of entirely of a metal, such as steel; cylinders comprised of metal liner and a composite “wrap” or reinforcement along the straight sides; cylinders comprised of a seamless metal liner that is completely wrapped on all surfaces by a composite reinforcement; and cylinders comprising a plastic liner and a full wrapping of carbon fiber or mixed fiber. In a further embodiment, the gas storage device is a type 1, type 2, type 3, or type 4 CNG cylinder. Typically, the gas storage device can comprise 5 to 30 gge (gasoline gallon equivalent) of a fuel gas (e.g., methane) or fuel gas mixture (e.g., natural gas). It should be noted that a gas storage device which comprises one or more MOFs of the disclosure is capable of storing more fuel gas than the gas storage device alone.

In a further embodiment, a gas storage device used to adsorb and/or absorb one or more component gases from a multi-component gas mixture comprises one or more MOFs disclosed herein. In a certain embodiment, a gas storage device used to adsorb and/or absorb methane, hydrogen, carbon dioxide, or water from gas mixture comprises one or more MOFs disclosed herein.

The disclosure also provides methods using the MOFs disclosed herein. In a certain embodiment, a method to separate or store one or more gases comprises contacting one or more gases with one or more MOFs disclosed herein. In a further embodiment, a method to separate or store one or more gases from a mixed gas mixture comprises contacting the gas mixture with one or more MOFs disclosed herein. In a certain embodiment, a method to separate or store one or more gases from a fuel gas stream comprises contacting the fuel gas stream with one or more MOFs disclosed herein. In another embodiment, a method

In a variation of this embodiment, the gaseous storage site comprises a MOF with a pore which has been functionalized with a group having a desired size or charge. In a refinement, this activation involves removing one or more chemical moieties (guest molecules) from the MOF disclosed herein. Typically, such guest molecules include species such as water, solvent molecules contained within the MOF disclosed herein, and other chemical moieties having electron density available for attachment.

The MOFs used in the embodiments of the disclosure include a plurality of pores for gas adsorption. In one variation, the plurality of pores has a unimodal size distribution. In another variation, the plurality of pores have a multimodal (e.g., bimodal) size distribution.

The following examples are intended to illustrate but not limit the disclosure. While they are typical of those that might be used, other procedures known to those skilled in the art may alternatively be used.

### Examples

### Materials

N,N-Dimethylformamide (DMF), formic acid (purity>98%) was obtained from EMD Millipore Chemicals; anhydrous acetone was obtained from Acros Organics; Aluminum nitrate nonahydrate [Al(NO₃)₃.9H₂O, purity≧98%] was obtained from Sigma-Aldrich Co. 4,4′,4″-benzene-1,3,5-tryil-tribenzoic acid, H₃BTB, was obtained from TCI America. Nitric acid (70%) was obtained from Sigma-Aldrich. Ultra-high-purity grade N₂, CH₄, and He (99.999% purity) gases were used for the gas adsorption experiments.

Single X-Ray Diffraction (SXRD) Analysis:

SXRD data were collected on a Bruker D8-Venture diffractometer equipped with Mo-(λ=0.71073 Å) and Cu-target (λ=1.54184 Å) micro-focus X-ray tubes and a PHOTON 100 CMOS detector. Additional data were collected using synchrotron radiation in the beamline 11.3.1 of the Advanced Light Source, LBNL.

Powder X-Ray Diffraction Patterns (PXRD):

PXRD were recorded using a Bruker D8 Advance diffractometer (Göbel-mirror monochromated Cu Kα radiation λ=1.54056 Å). Room-temperature neutron powder diffraction data are collected on the high-resolution neutron powder diffractometer, BT1, using a Ge(311) monochromator (λ=2.0781 Å) and a 60 minute collimator.

Elemental Microanalysis (EA):

Solution ¹H NMR spectra were acquired on a Bruker AVB-400 NMR spectrometer. EA were performed using a Perkin Elmer 2400 Series II CHNS elemental analyzer.

Thermal Gravimetric Analysis:

TGA curves were recorded on a TA Q500 thermal analysis system under nitrogen flow.

Low Pressure Isotherm Analysis:

Low-pressure gas (N₂ and Ar) adsorption isotherms were recorded using a Quantachrome Autosorb-1 volumetric gas adsorption analyzer. A liquid nitrogen bath was used for the measurements at 77 K. A water circulator was used for adsorption measurements at 273, 283, and 298 K.

High-Pressure Isotherm Analysis:

High-pressure methane adsorption isotherms for MOF-519 and MOF-520 equilibrium gas adsorption isotherms were measured using the static volumetric method in an HPA-100 from the VTI Corporation (currently Particulate Systems).

Synthesis of MOF-519 [Al₈(OH)₈(BTB)₄(H₂BTB)₄]:

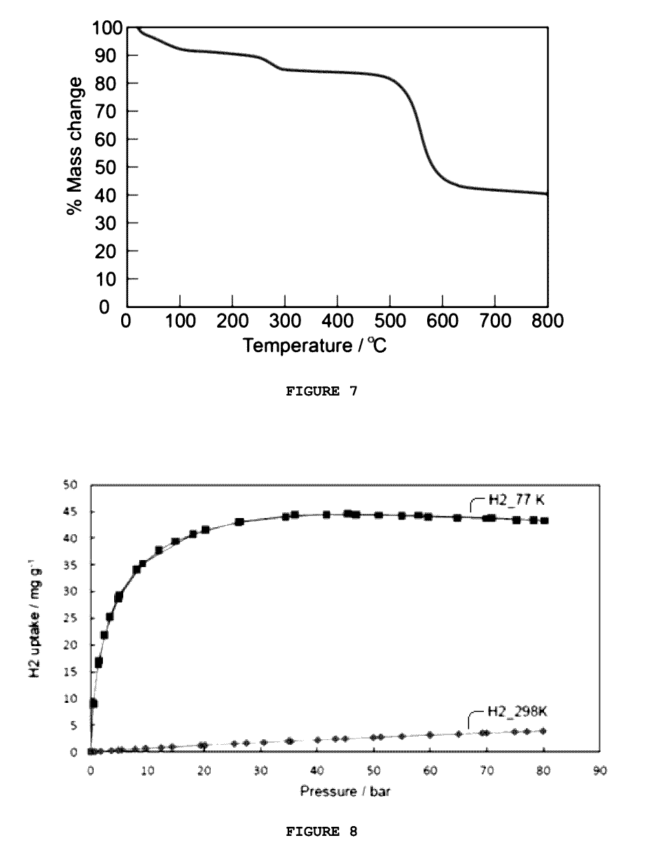

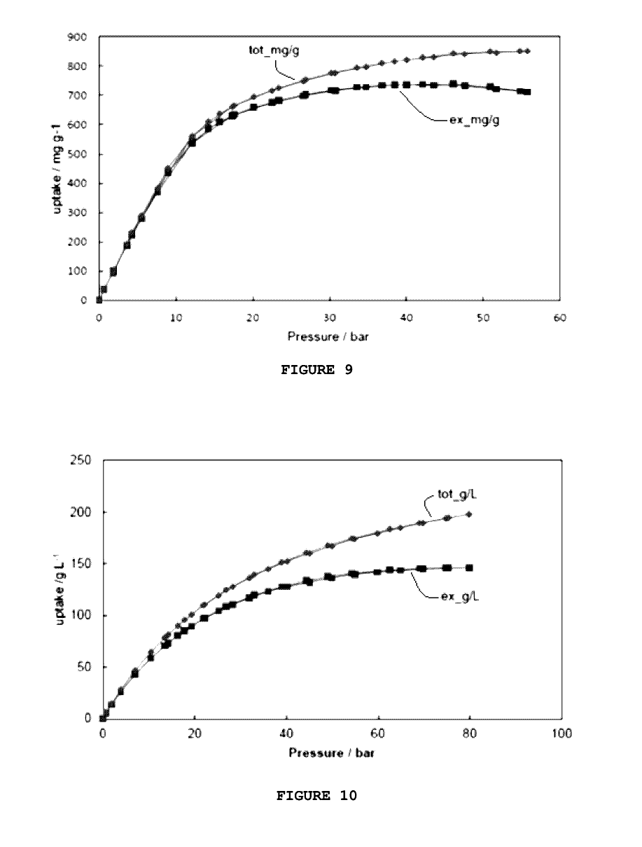

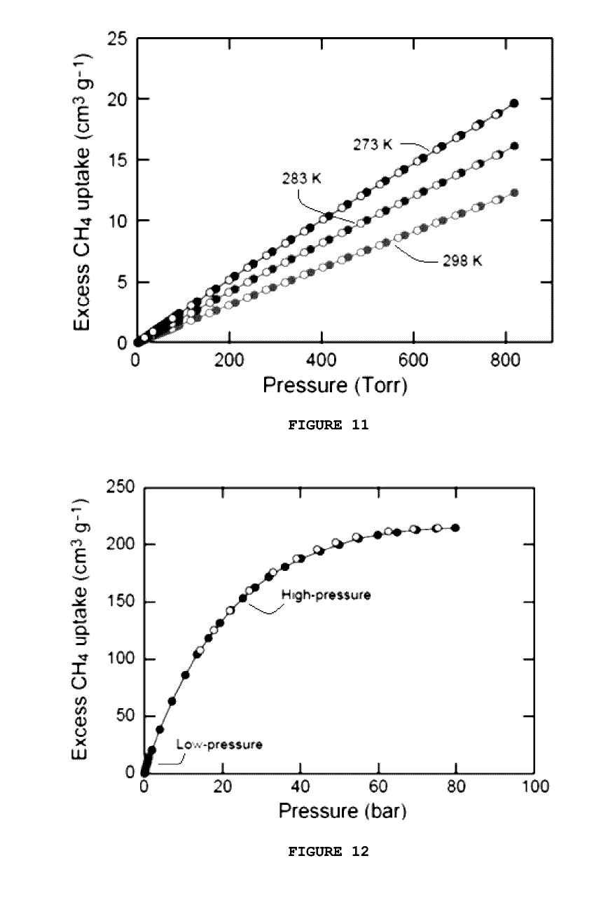

Synthesis of MOF-519 was carried out as follows: benzenetribenzoic acid (H₃BTB; 109 mg) was dissolved in anhydrous N,N-dimethylformamide (DMF) (9 mL). A freshly prepared 0.2 M stock solution of aluminum nitrate in DMF (0.675 mL) was added, followed by the addition of nitric acid (0.675 mL). The reaction mixture was placed in a Teflon lined vessel. The Teflon vessel was then sealed and placed in a stainless steel Parr autoclave. The autoclave was placed in an oven preheated at 150° C., and kept in the oven for 72 hours. After heating, it was cooled down to room temperature. A white product was obtained, which was separated from the mother liquid by centrifugation at 4400 rpm for 10 minutes. The solid was then washed with anhydrous DMF (10 mL) and centrifuged two times. Then it was immersed in anhydrous acetone (12 mL). The acetone was exchanged five times over a period of 48 hours. The solid was then transferred to a cellulose extraction thimble which was place in a Tousimis supercritical point dryer, and immersed in liquid CO₂. The CO₂ was replaced five times over a period of 4 hours. The CO₂ was taken to supercritical conditions and it was slowly bled off overnight. E.A.: Found (wt %): C: 59.98; H: 3.92; N: <0.2. Calculated for [Al₈(OH)₈(BTB)₄(H₂BTB)₄].22H₂O═C: 61.32; H: 4.10; N: 0.0. The amount of water included in the calculated formula corresponds to a 9.3 wt %, which is consistent with the 9% mass loss at T=100° C. observed in the TGA curve of this sample (see FIG. 7).

In order to obtain a single-crystal of MOF-519, H₃BTB (10.9 mg) was dissolved in anhydrous DMF (0.45 mL). A freshly prepared 0.065 M stock solution of aluminum nitrate in DMF (0.2 mL) was then added, followed by the addition of nitric acid (0.150 mL). The Teflon vessel was then sealed and placed in a stainless steel Parr autoclave. The autoclave was placed in an oven preheated at 150° C., and kept in the oven for 72 hours. After heating, it was cooled down to room temperature.

Synthesis of MOF-520 [Al₈(OH)₈(OOCH)₄(BTB)₄]:

H₃BTB (75 mg) was dissolved in DMF (2 mL). A freshly prepared 0.02 M stock solution of aluminum nitrate in DMF (2 mL) was added followed by the addition of DMF (13 mL) and formic acid (1.4 mL). The 20-mL vial was placed in an oven preheated at 130° C., and kept in the oven for 72 hours. After heating, it was cooled down to room temperature. The obtained crystals were washed with DMF (20 mL) three times. The crystals were then immersed in acetone (20 mL). The acetone was exchanged five times over a period of 48 hours. The single crystals were then transferred to a cellulose extraction thimble which was place in a Tousimis supercritical point dryer, and immersed in liquid CO₂. The CO₂ was replaced five times over a period of 4 hours. The CO₂ was taken to supercritical conditions and it was slowly bled off overnight. Finally, the single crystals were fully activated by heating at 120° C. under vacuum at 30 mTorr for 3 hours. E.A.: Found (wt %): C: 59.20; H: 3.20; N: <0.2. Calculated for Al₈(OH)₈(OOCH)₄(BTB)₄═C: 58.81; H: 3.14; N: 0.0.

Synthesis of MOF-521 [Al₃(OH)₃(HCOO)₃BTB]:

Al(NO₃).9H₂O (90 mg; 0.240 mmol) and H₃BTB (75 mg; 0.171 mmol) were added to a 20 mL vial. DMF (14 mL) was added to the vial, and the vial was then sonicated for 10 min at ambient temperature. Formic acid (1.4 mL) was then added to the solution. The solution was placed in a preheated 130° C. oven for 48 hours. The resulting single crystals of MOF-521 were obtained from the wall of the vial.

Single Crystal X-Ray Diffraction Analyses: MOF-519:

A crystal of MOF-519 was collected at the beamline 24-ID-C at Advanced Photon Source (Argonne National Laboratory). A crystal of 0.04×0.02×0.02 mm of dimensions was selected, and data was collected with wavelength=0.8903 Å, to a maximum resolution of 1.0 Å. All the tested specimens were found to be twinned. The structure was solved in the tetragonal space group P4₂2₁2 using direct methods as implemented in SIR2008 according to the methods of (a) Burla et al. (“SIR2004: an improved tool for crystal structure determination and refinement,” Journal of Applied Crystallography 38:381 (2005)) and (b) Burla et al. (“SIR2011: a new package for crystal structure determination and refinement,” Journal of Applied Crystallography 45:357 (2012)). Full-matrix least-squares refinements on F² were carried out using ShelXL and OLEX2 according to the methods of Sheldrick et al. (“A short history of SHELX,” Acta Crystallographica Section A 64:112 (2008)) and Dolomanov et al. (“OLEX2: a complete structure solution, refinement and analysis program,” Journal of Applied Crystallography 42:339 (2009)), respectively. After location of all the framework atoms in the different Fourier maps, the squeeze routine in PLATON was run according to the methods of Spek, A. (“Structure validation in chemical crystallography,” Acta Crystallographica Section D-Biological Crystallography 65:148 (2009)) and additional refinements were carried out. The framework atoms were refined anisotropically, while the atoms belonging to the dangling H₂BTB molecules were kept isotropic because they exhibited large ADP parameters, which were attributed to the different rotational degrees of freedom for these molecules. The limited resolution and the low diffracting quality of the specimens resulted in the presence of A alerts in the checkcif file regarding to the value of sin Ø/λ being smaller than 0.55, and to the presence of isotropic atoms in the asymmetric units, as explained above.

The crystal data and structural refinements for MOF-519 are presented in TABLE 1.

TABLE 1
Crystal data and structure refinement for MOF-519

| Identification code | MOF-519 | |
|---|---|---|
| Empirical formula | C₂₁₆H₆₀Al₈O₅₆ | |
| Formula weight | 3766.48 | |
| Temperature | 293(2) K | |
| Wavelength | 0.89030 Å | |
| Crystal system | Tetragonal | |
| Space group | P4₂2₁2 | |
| Unit cell dimensions | a = 19.2800(10) Å | α = 90° |
| | b = 19.2800(10) Å | β = 90° |
| | c = 36.0300(10) Å | γ = 90° |

| | |
|---|---|
| Volume | 13393.0(11) Å³ |
| Z | 2 |
| Density (calculated) | 0.934 Mg/m³ |
| Absorption | 0.168 mm⁻¹ |
| coefficient | |
| F(000) | 3816 |
| Crystal size | 0.04 × 0.02 × 0.02 mm³ |
| Theta range for data | 1.94 to 26.40° |
| collection | |
| Index ranges | −19 <= h <= 19, |
| | −18 <= k <= 19, |
| | −35 <= l <= 35 |
| Reflections collected | 41675 |
| Independent | 6936 [R(int) = 0.1712] |
| reflections | |
| Completeness to theta = | 99.2% |
| 26.40° | |
| Refinement method | Full-matrix least- |
| | squares on F² |
| Data/restraints/ | 6936/12/269 |
| parameters | |
| Goodness-of-fit on F² | 1.057 |
| Final R indices | R1 = 0.1112, wR2 = |
| [I > 2sigma(I)] | 0.2792 |
| R indices (all data) | R1 = 0.1122, wR2 = |
| | 0.2892 |
| Absolute structure | 0.0(11) |
| parameter | |
| Largest diff. peak | 0.535 and −0.772 e · Å⁻³ |
| and hole | |

MOF-520:

An acetone-exchanged crystal of MOF-520 was collected at the beamline 11.3.1 at Advanced Light Source (Lawrence Berkeley National Laboratory). A crystal of 0.1×0.06×0.04 mm of dimensions was selected, and data was collected with wavelength=0.95403 Å, to a maximum resolution of 0.9 Å. The structure was solved in the tetragonal space group P4₂2₁2 using direct methods as implemented in Shelx. Full-matrix least-squares refinements on F² were carried out using ShelXL and OLEX2. Initially, a Flack parameter of 0.5 was found, which indicates the presence of both enantiomers in the crystal. In the final refinement, the BASF parameter was refined resulting in a value of 0.38 (0.17).

The crystal data and structural refinements for MOF-520 are presented in TABLE 2.

TABLE 2
Crystal data and structure refinement for MOF-520

| Identification code | MOF-520 | |
|---|---|---|
| Empirical formula | C₁₁₅H₇₆Al₈O₄₁ | |
| Formula weight | 2329.59 | |
| Temperature | 100 K | |
| Crystal system | Tetragonal | |
| Space group | P4₂2₁2 | |
| Unit cell dimensions | a = 18.878(4) Å | α = 90° |
| | b = 18.878(4) Å | β = 90° |
| | c = 37.043(8) Å | γ = 90° |

| | |
|---|---|
| Z | 2 |
| Density (calculated) | 0.586 Mg/m³ |
| Absorption | 0.161 mm⁻¹ |
| coefficient | |
| F(000) | 2396.0 |
| Crystal size | 0.08 × 0.03 × 0.02 mm³ |
| 2Ø range for data | 5.292 to 64.06° |
| collection | |
| Index ranges | −18 <= h <= 20, |
| | −17 <= k <= 20, |
| | −41 <= l <= 40 |
| Reflections collected | 45424 |
| Independent | 9440[R(int) = 0.0829, |
| reflections | Rsigma = 0.0667] |
| Data/restraints/ | 9440/0/372 |
| parameters | |
| Goodness-of-fit on F² | 1.173 |
| Final R indices | R1 = 0.0887, wR2 = |
| [I > 2σ(I)] | 0.2547 |
| Final R indices (all | R1 = 0.1055, wR2 = |
| data) | 0.2734 |
| Largest diff. peak | 1.00/−0.52 e · Å⁻³ |
| and hole | |
| Flack parameter | 0.4(2) |

High-Pressure Methane Adsorption Measurements.

High-pressure methane adsorption isotherms for MOF-519 and 520 equilibrium gas adsorption isotherms were measured using the static volumetric method in an HPA-100 from the VTI Corporation (currently Particulate Systems). Ultra-high-purity grade CH₄ and He (99.999% purity) gases were used throughout the high-pressure adsorption experiments. A water circulator was used for adsorption measurements at 298 K. In the case of MOF-519, two independent measurements were carried out with two different sample batches that were prepared under the same conditions. The measurements were performed 22 months apart.

Estimation of Total Methane Uptake.

The total methane uptake was determined by using a simple equation, since it is not possible to estimate experimentally: (total uptake)=(excess uptake)+(bulk density of methane)×(pore volume). The dual-site Langmuir model according to EQ. 1:

$$\frac{{V}_{1} \times {K}_{1} P}{( 1 + {K}_{1} P )} + \frac{{V}_{2} \times {K}_{2} P}{( 1 + {K}_{2} P )} \qquad ( Eq . 1 )$$

was used to estimate the methane uptake up to 250 bar, where V₁, V₂, K₁, and K₂ are parameters and P is pressure.

Characterization of MOF-519:

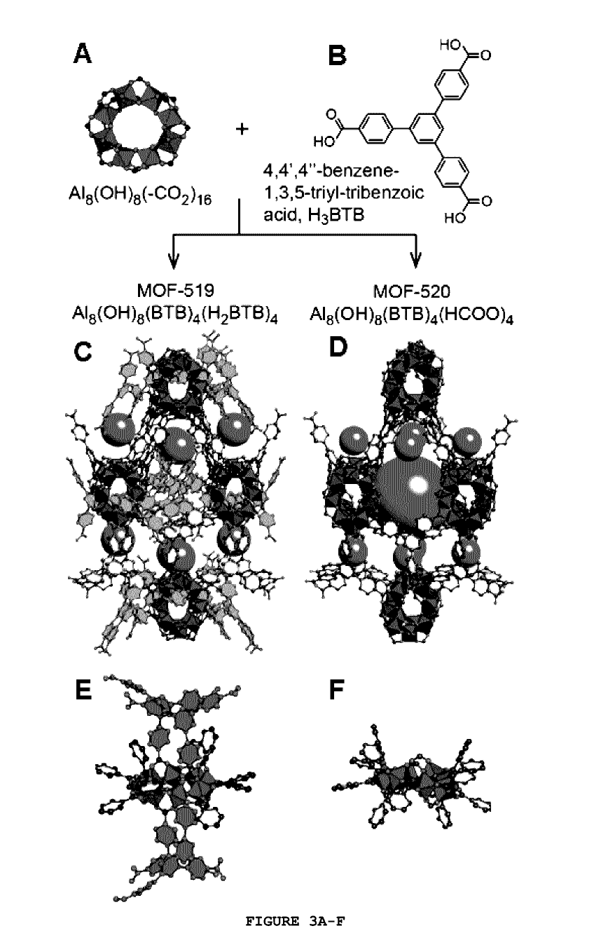

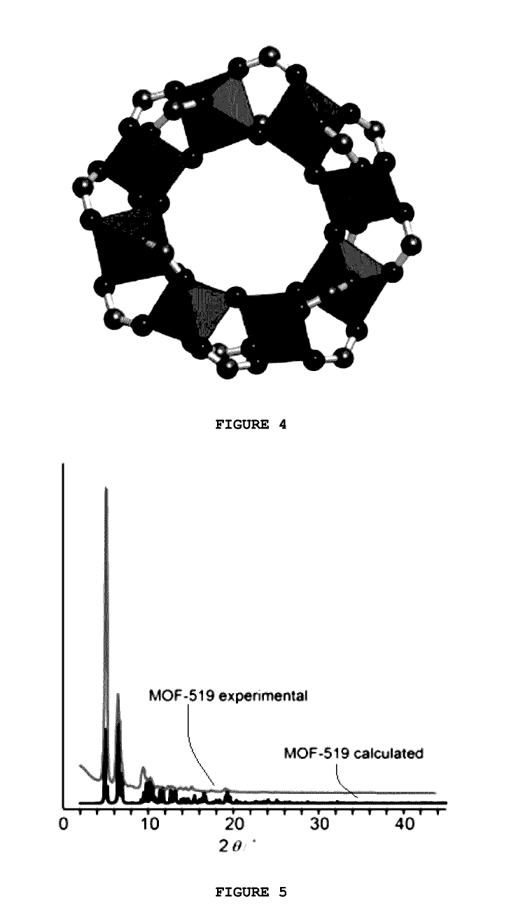

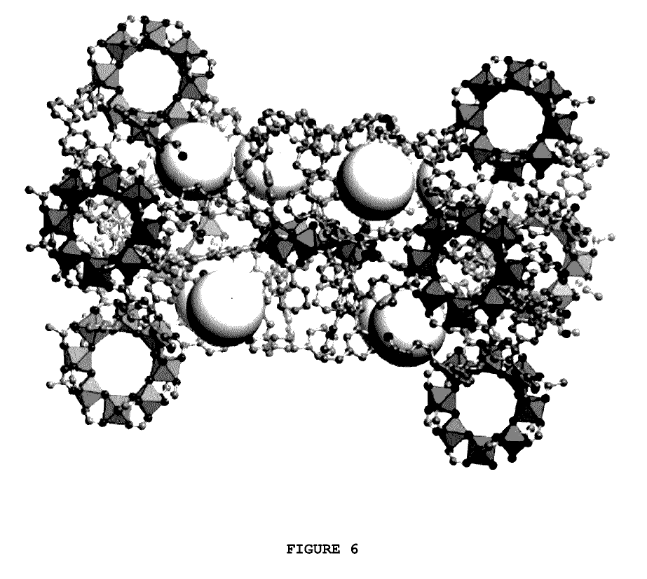

MOF-519 was determined to have a Langmuir surface area of 2200 m² g⁻¹ and possessed an extraordinary high volumetric capacity of 198 g L⁻¹ at room temperature and 80 bar. Microcrystalline powder of MOF-519 was used to measure the methane uptake capacity. The sample was prepared by heating a mixture containing aluminum nitrate, H₃BTB, nitric acid, and N,N-dimethylformamide (DMF) at 150° C. for 4 days. A modified synthesis with higher concentration of nitric acid resulted in lower yield but afforded a single crystal, which was used to determine the crystal structure of the MOF-519 (See TABLE 1). The material crystallizes in the tetragonal space group P4₂2₁2. The inorganic secondary building unit (SBU) of MOF-519 comprises eight octahedrally coordinated aluminum atoms that are corner joined by doubly bridging OH groups (see FIG. 3A and FIG. 4). The vertex-sharing arrangement of octahedral atoms in MOF-519, contrasts with the rod-shaped metal oxide SBUs seen with other aluminum MOFs. MOF-519 utilizes 12 carboxylate BTB links (colored light gray in FIGS. 3C and 3E) to build the extended structure and further comprises 4 terminal BTB ligands (colored medium gray in FIGS. 3C and 3E). The latter are linked only by one of their carboxylates to the SBU, with the remaining two carboxylates protruding into the interior of the three-dimensional structure of this MOF. The overall framework topology of MOF-519 is a (12,3)-connected net, which can be simplified to the topological type sum. In MOF-519 sinusoidal channels are formed and are connected by windows of maximum diameter of 7.6 Å, as determined by PLATON.

Characterization of MOF-520:

Crystals of MOF-520 were prepared under different synthetic conditions than MOF-519 by substituting formic acid for nitric acid. MOF-520 has a crystal structure that is closely related to that of MOF-519. It crystallizes in the same space group and with similar lattice parameters (see TABLE 2). It is composed of the same octametallic SBU, and it has the same overall framework topology, but instead of four terminal BTB ligands, it has four formate ligands (see FIGS. 3D and 3F). This allows for a larger void space in MOF-520 (16.2×9.9 Å) (See FIGS. 3D and 3F) compared to MOF-519.

Nitrogen Isotherms of MOF-519 and MOF-520.

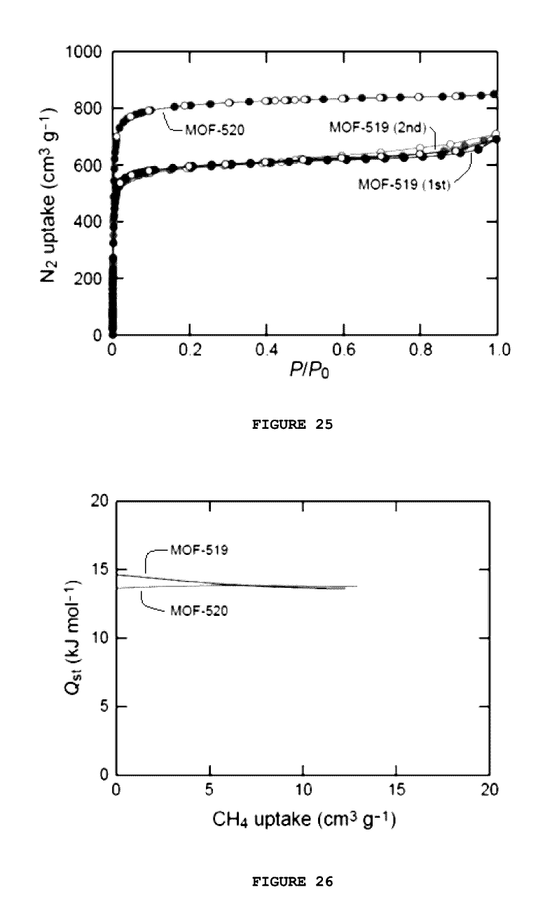

Prior to the methane adsorption measurements, the nitrogen isotherms of MOF-519 and MOF-520 were recorded at 77 K to confirm the presence of the permanent microporosity. Both MOFs showed steep nitrogen uptake below P/P₀=0.05, and the uptake values were nearly saturated around P/P₀=0.2 (see FIG. 25). Nitrogen molecules were desorbed when the pressure was reduced, which clearly indicates that these MOFs have permanent microporosity. The nitrogen uptake by MOF-520 is greater than MOF-519 due to the absence of pore protruding BTB ligands. MOF-520, therefore, has larger pore volume than MOF-519 (0.94 and 1.28 cm³ g⁻¹ for MOF-519 and MOF-520, respectively). The BET (Langmuir) surface areas of MOF-519 and MOF-520 are estimated to be 2400 (2660) m² g⁻¹ and 3290 (3630) m² g⁻¹, respectively.

Methane Adsorption Isotherms for MOF-519 and MOF-520.

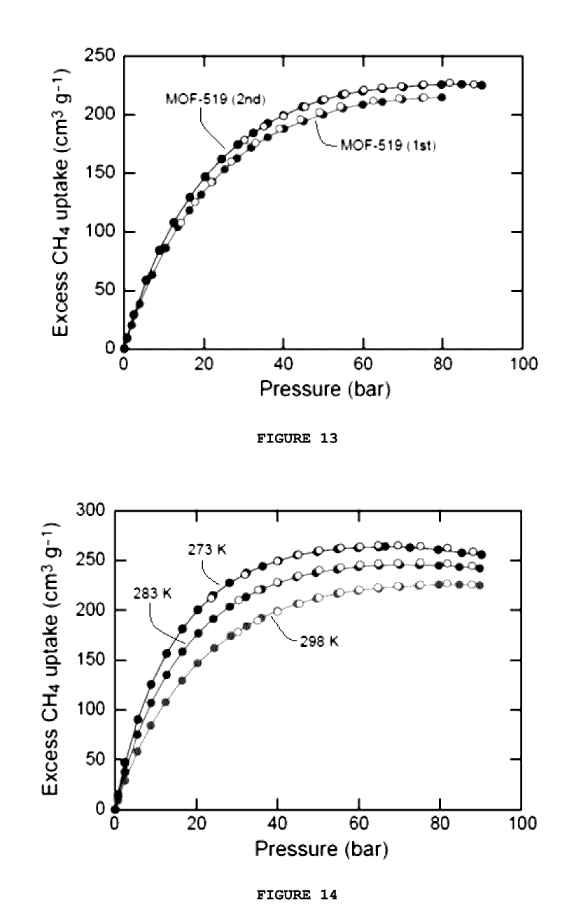

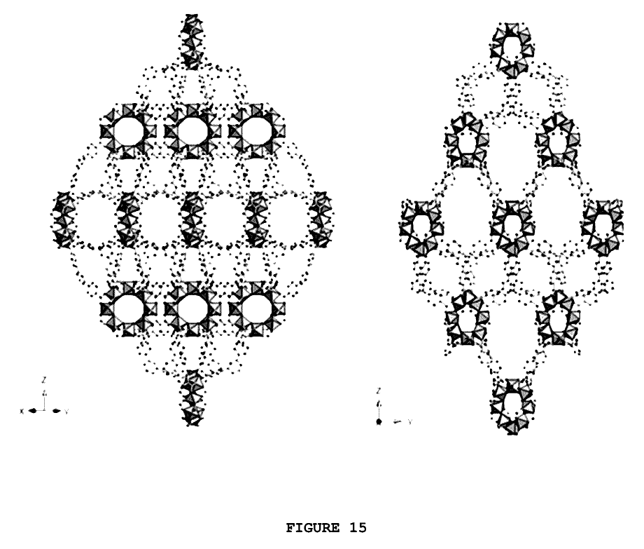

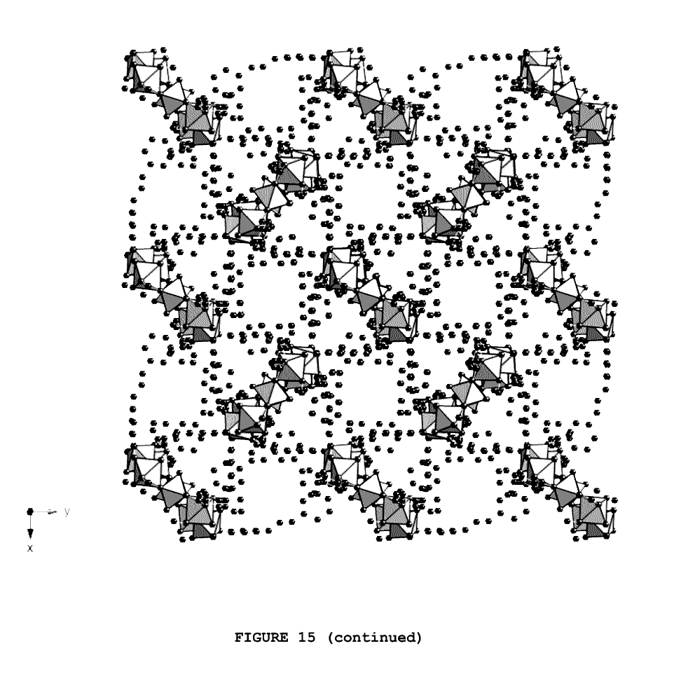

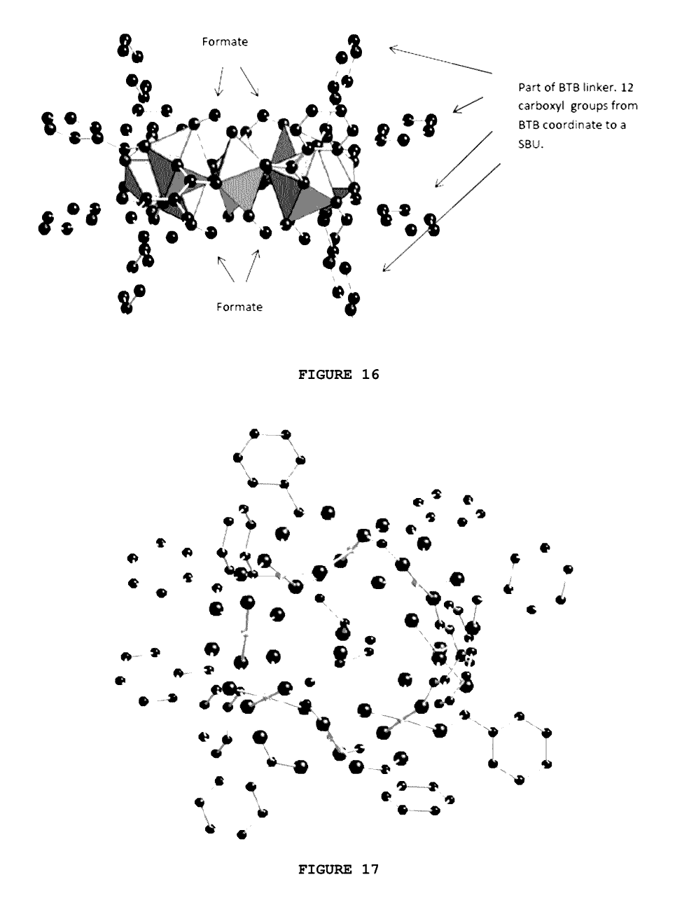

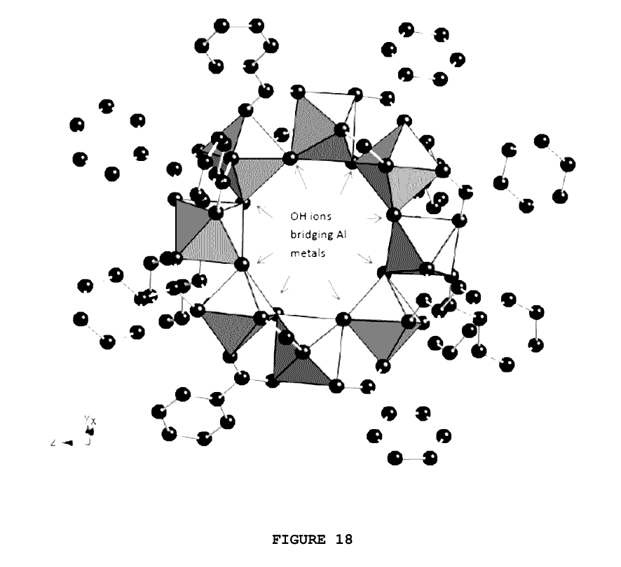

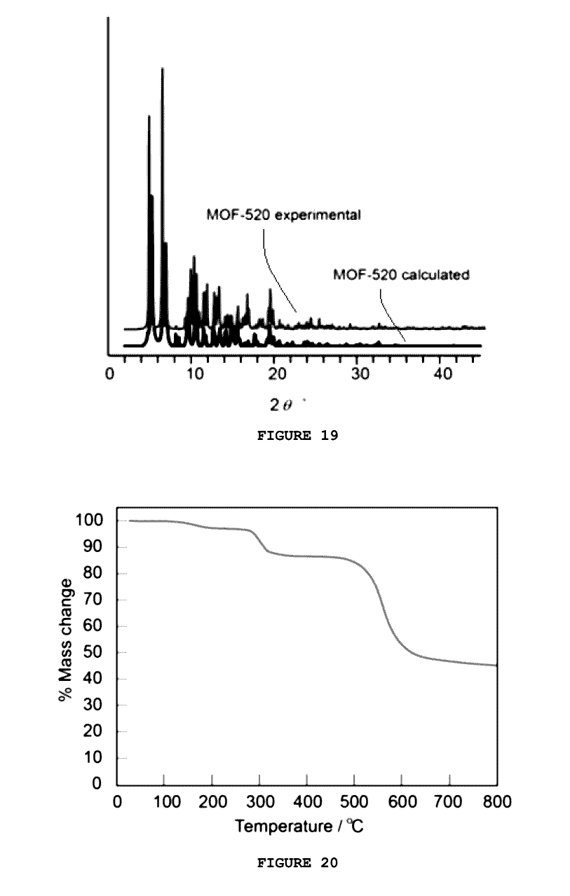

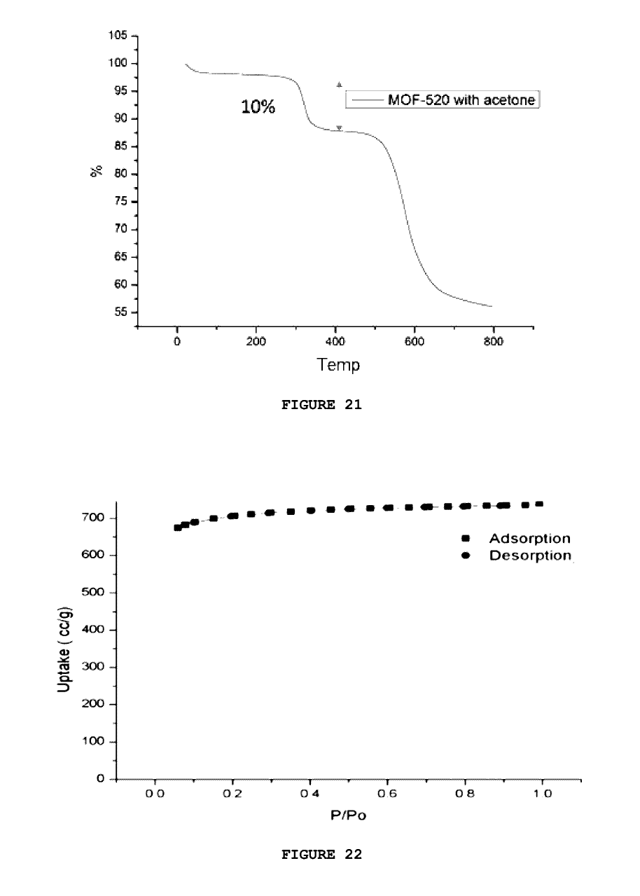

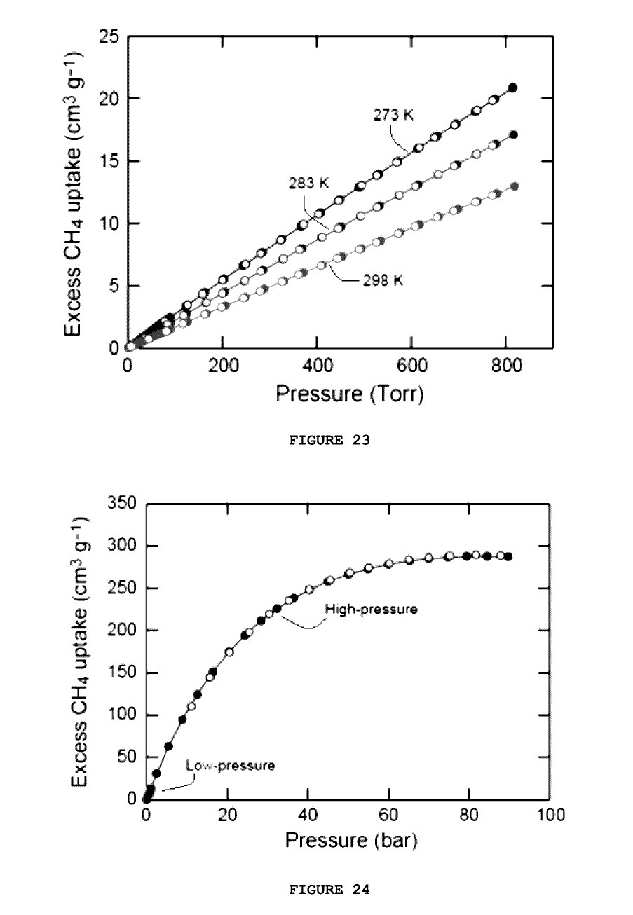

Methane adsorption isotherms were measured at 298 K using a high-pressure volumetric gas adsorption analyzer. The excess methane isotherms for MOF-519 and MOF-520 are shown in FIGS. 12-14, and FIG. 24. Initially the methane uptake increases with an increase in the pressure, while the uptake saturates at around 80 bar (215 and 288 cm³ g⁻¹ for MOF-519 and MOF-520, respectively). In terms of the gravimetric uptake capacity, MOF-520 outperforms MOF-519 up to 80 bar, which is not surprising because of the larger surface area and pore volume of MOF-520. Considering the practical application of methane storage, the total volumetric methane uptake is rather relevant. Therefore, the total volumetric methane uptake was estimated using the crystal density of MOFs and the following equation: total uptake=excess uptake+(bulk density of methane)×(pore volume).

As shown in FIG. 34, MOF-519 shows high total volumetric methane uptake capacity. Considering that MOF-519 does not have strong binding sites (e.g., open metal sites), it is likely that the average pore diameter of MOF-519 is of optimal size to confine methane molecules in the pore. In FIG. 2, the total uptake and the working capacity of MOF-519 and MOF-520 were compared with the materials that have been recently identified as the best methane adsorbents. At 35 bar, the total uptake capacity of MOF-519 (200 cm³ cm⁻³) is approaching that of Ni-MOF-74 (230 cm³ cm⁻³). At 80 bar MOF-519 outperforms any other reported MOF, with a total volumetric capacity of 279 cm³ cm⁻³.

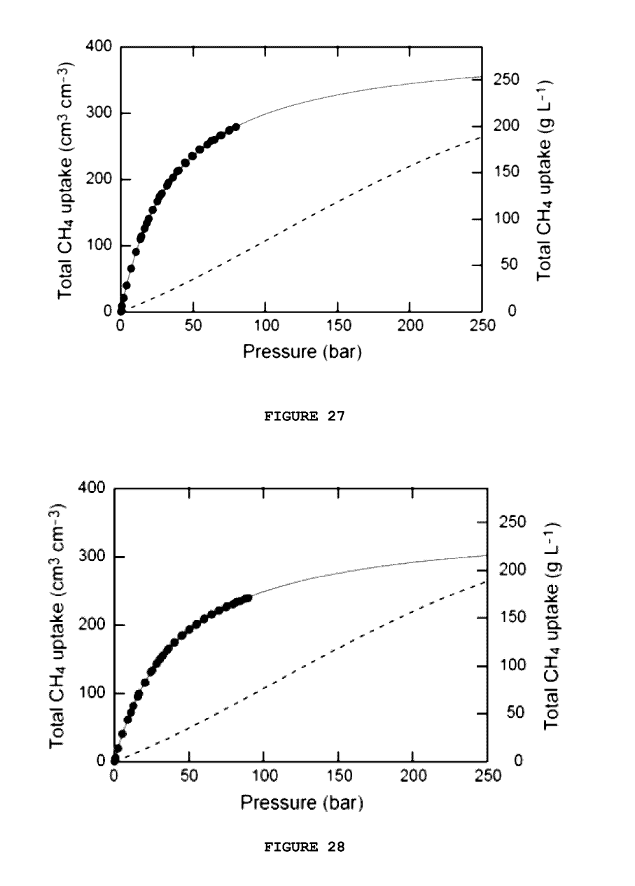

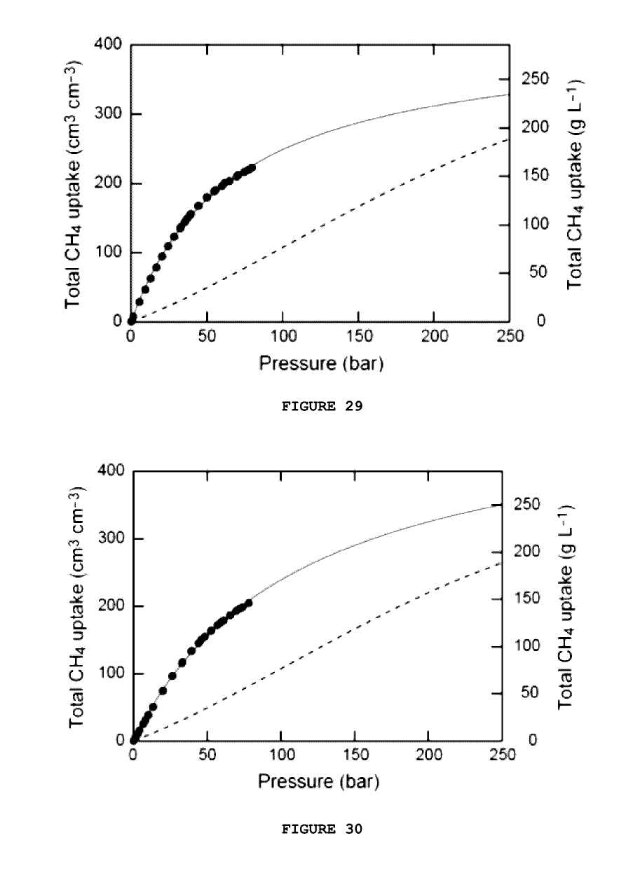

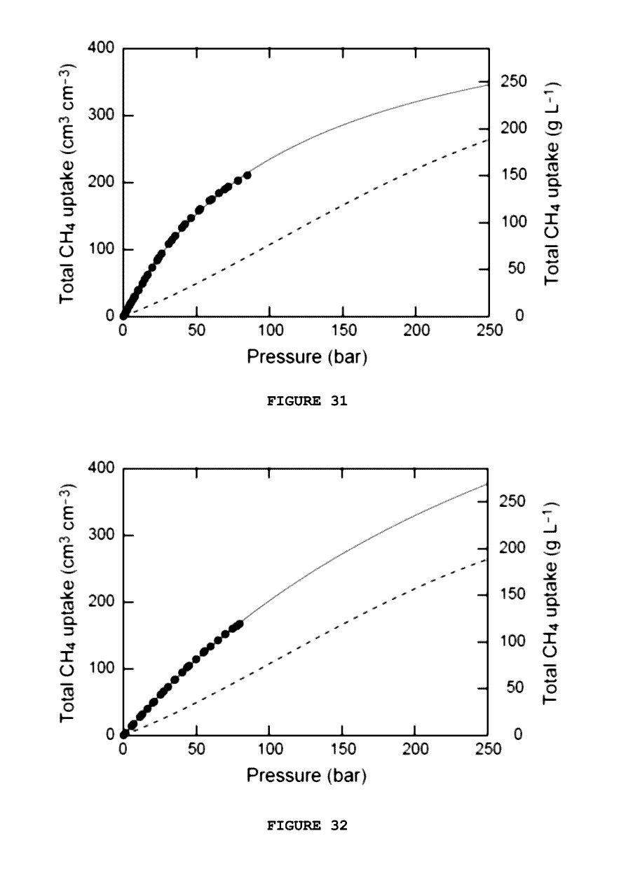

Since MOF-519 shows high total volumetric uptake capacity, it was also evaluated whether this material can exceed the energy density of compressed natural gas (CNG) at 250 bar (which is a pressure value used for some natural gas fueled automobiles). Here, the total volumetric uptake of MOF-519 and MOF-520 was calculated by extrapolation of the total uptake isotherm using a dual site Langmuir model (see FIGS. 27 and 28) and found to be 355 cm³ cm⁻³, far exceeding CNG (263 cm³ cm⁻³). The same model was used to calculate the uptake for other methane adsorbents (see FIGS. 29 to 32), and with this fitting data, the working capacity of methane (desorption pressure is at 5 bar) was obtained (see FIG. 2 and FIG. 33). The working capacity of MOF-519 at 35 bar is 151 cm³ cm⁻³, while at 80 bar this MOF is able to deliver 230 cm³ cm⁻³, which is the largest obtained for any of the top performing MOFs and porous carbon AX-21. At 80 bar, a tank filled with MOF-519 would deliver almost three times more methane than an empty tank.

Characterization of MOF-521:

MOF-521 crystallized in the hexagonal space group P31c, with unit cell parameters a=21.915 Å and c=6.607 Å. MOF-521 was determined to have a Langmuir surface area of greater than 2160 m² g⁻¹. MOF-521 was found to be highly stable. MOF-521 decomposed at a temperature of ˜560° C. and was stable in water. MOF-521 was found to have a relatively small pore size of 5˜10 Å. This pore size is ideal for hydrogen and water storage.

A number of embodiments have been described herein. Nevertheless, it will be understood that various modifications may be made without departing from the spirit and scope of this disclosure. Accordingly, other embodiments are within the scope of the following claims.

1. A Metal-Organic Framework (MOF) comprising a plurality of linked M-O-L Secondary Building Units (SBUs), wherein M is a metal, metal ion, or metal containing complex; O is an oxygen atom of a carboxylate based linking cluster; and L is an organic linking ligand comprising one or more structures of any one of Formula I-V: 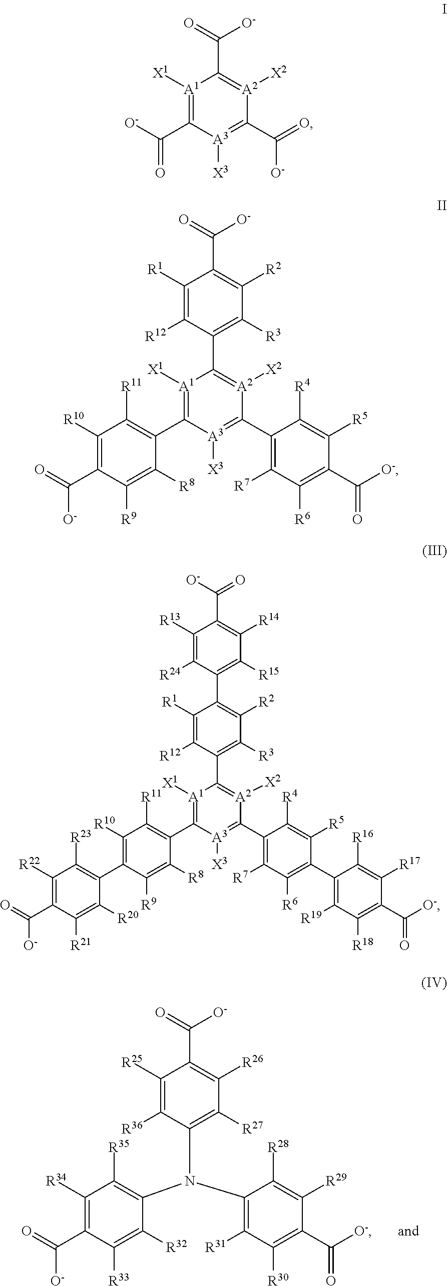 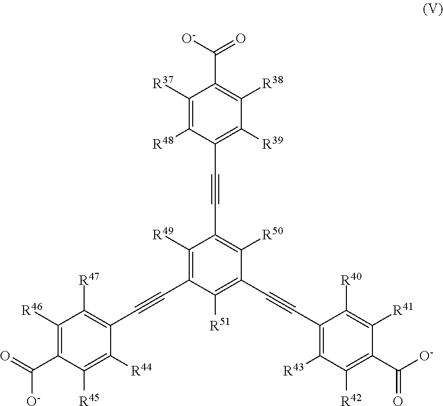
wherein,
A¹-A³ are independently a C, N, O, or S;
X¹-X³ are independently selected from H, D, functional group (“FG”), optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more optionally substituted rings selected from cycloalkyl, cycloalkenyl, heterocycle, aryl, and mixed ring system; and
R¹-R⁵¹ are independently selected from H, D, FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more optionally substituted rings selected from the group comprising cycloalkyl, cycloalkenyl, heterocycle, aryl, and mixed ring system;
wherein the SBUs of the MOF optionally comprises one or more pendant linkers and/or one or more modulators; and
wherein the MOF is characterized by having a large number of adsorption sites per unit of volume.

2. The MOF of claim 1, wherein the MOF comprises a plurality of linked M-O-L Secondary Building Units (SBUs), wherein M is a metal, metal ion, or metal containing complex; O is an oxygen atom of a carboxylate based linking cluster; and L is an organic linking ligand comprising one or more structures of any one of Formula I-V: 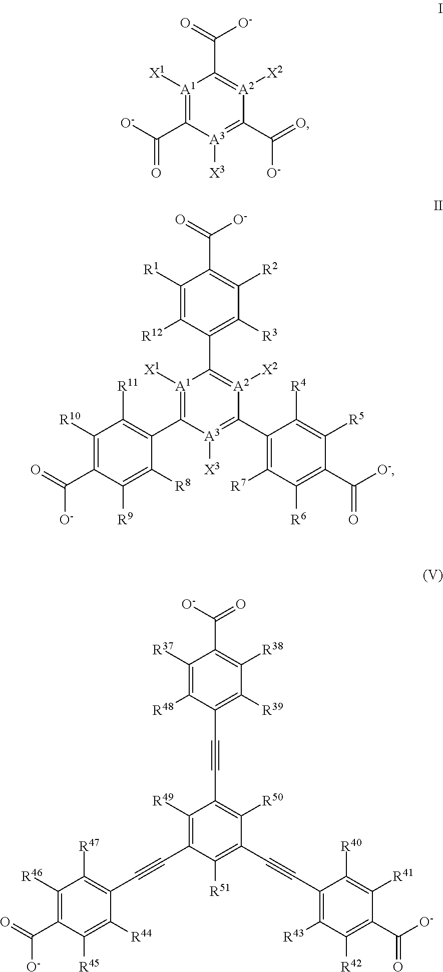
wherein,
A¹-A³ are independently a C or N;
X¹-X³ are independently selected from H, D, FG, optionally substituted (C₁-C₆)alkyl, optionally substituted (C₁-C₆)heteroalkyl, optionally substituted (C₁-C₆)alkenyl, optionally substituted (C₁-C₆)heteroalkenyl, optionally substituted (C₁-C₆)alkynyl, optionally substituted (C₁-C₆)heteroalkynyl, optionally substituted (C₁-C₆)cycloalkyl, optionally substituted (C₁-C₆)cycloalkenyl, optionally substituted aryl, optionally substituted heterocycle, optionally substituted mixed ring system, wherein one or more adjacent R groups can be linked together to form one or more optionally substituted rings selected from the group comprising cycloalkyl, cycloalkenyl, heterocycle, aryl, and mixed ring system; and
R¹, R³-R⁵, R⁷-R⁹, R¹¹-R¹³, R¹⁵-R¹⁷, R¹⁹-R²¹, R²³-R²⁵, R²⁷-R²⁹, R³¹-R³³, R³⁵-R³⁶, R³⁷, R³⁹-R⁴¹, R⁴³-R⁴⁵, and R⁴⁷-R⁵¹ are H; and
R², R⁶, R¹⁰, R¹⁴, R¹⁸, R²², R²⁶, R³⁰, R³⁴, R³⁸, R⁴², and R⁴⁶ are independently selected from amine, methyl, hydroxyl, ═O, ═S, halo, optionally substituted aryl, optionally substituted aryloxy, alkoxy, —O—(CH₂)ₙ—CH₃, and —O—(CH₂)₂—O—CH₂—CH₃, wherein n is an integer from 1 to 5;
wherein the SBUs of the MOF optionally comprises one or more pendant linkers and/or one or more modulators; and
wherein the MOF is characterized by having a large number of adsorption sites per unit of volume.

3. The MOF of claim 2, wherein the MOF comprises a plurality of linked M-O-L Secondary Building Units (SBUs), wherein M is a metal, metal ion, or metal containing complex; O is an oxygen atom of a carboxylate based linking cluster; and L is an organic linking ligand comprising one or more structures of any one of Formula I(a), II(a), III(a), IV(a), and V(a): 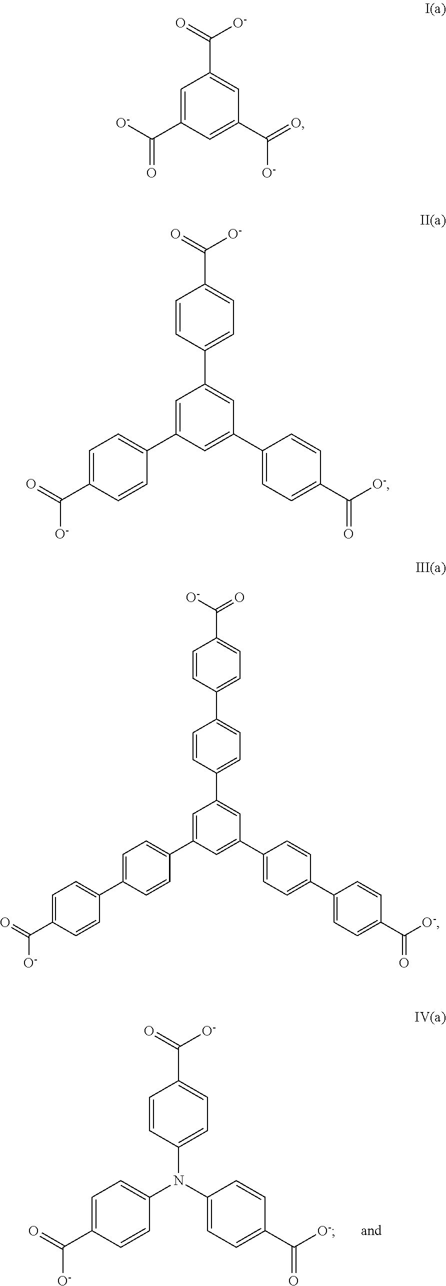 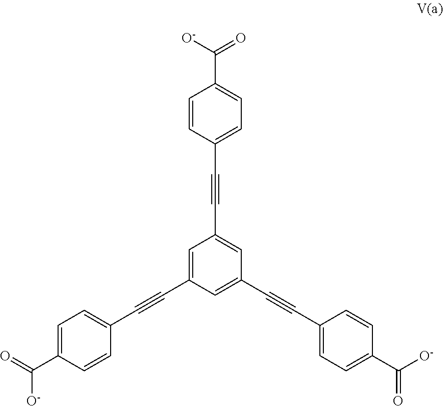 [SMILES: O=C([O-])c1ccc(C#Cc2cc(C#Cc3ccc(C(=O)[O-])cc3)cc(C#Cc3ccc(C(=O)[O-])cc3)c2)cc1]
wherein the SBUs of the MOF optionally comprises one or more pendant linkers and/or one or more modulators; and
wherein the MOF is characterized by having a large number of adsorption sites per unit of volume.

4. The MOF of claim 3, wherein the MOF comprises a plurality of linked M-O-L Secondary Building Units (SBUs), wherein M is a metal, metal ion, or metal containing complex; O is an oxygen atom of a carboxylate based linking cluster; and L is an organic linking ligand comprising a structure of Formula II(a): 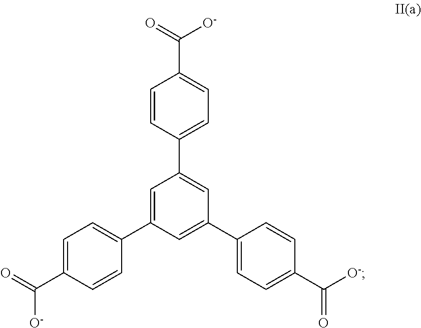
and
wherein the SBUs of the MOF optionally comprises one or more pendant linkers and/or one or more modulators; and
wherein the MOF is characterized by having a large number of adsorption sites per unit of volume.

5. The MOF of claim 1, wherein each SBU of the MOF comprises at least 8 metal or metal ions coordinated to a plurality of organic linking ligands.

6. The MOF of claim 5, wherein each SBU comprises octahedrally coordinated metal or metal ions that are cornered joined by doubly bridging OH groups.

7. The MOF of claim 6, wherein each SBU has a ring-shaped motif.

8. The MOF of claim 1, wherein each SBU comprises 10 to 16 organic linking ligands coordinated to a plurality of metal or the metal ions.

9. The MOF of claim 1, wherein M is a metal or metal ion selected from: Li⁺, Na⁺, K⁺, Rb⁺, Cs⁺, Be²⁺, Mg²⁺, Ca²⁺, Sr²⁺, Ba²⁺, Sc³⁺, Sc²⁺, Sc⁺, Y³⁺, Y²⁺, Y⁺, Ti⁴⁺, Ti³⁺, Ti²⁺, Zr⁴⁺, Zr³⁺, Zr²⁺, Hf⁴⁺, Hf³⁺, V⁵⁺, V⁴⁺, V³⁺, V²⁺, Nb⁵⁺, Nb⁴⁺, Nb³⁺, Nb²⁺, Ta⁵⁺, Ta⁴⁺, Ta³⁺, Ta²⁺, Cr⁶⁺, Cr⁵⁺, Cr⁴⁺, Cr³⁺, Cr²⁺, Cr⁺, Cr, Mo⁶⁺, Mo⁵⁺, Mo⁴⁺, Mo³⁺, Mo²⁺, Mo⁺, Mo, W⁶⁺, W⁵⁺, W⁴⁺, W³⁺, W²⁺, W⁺, W, Mn⁷⁺, Mn⁶⁺, Mn⁵⁺, Mn⁴⁺, Mn³⁺, Mn²⁺, Mn⁺, Re⁷⁺, Re⁶⁺, Re⁵⁺, Re⁴⁺, Re³⁺, Re²⁺, Re⁺, Re, Fe⁶⁺, Fe⁴⁺, Fe³⁺, Fe²⁺, Fe⁺, Fe, Ru⁸⁺, Ru⁷⁺, Ru⁶⁺, Ru⁴⁺, Ru³⁺, Ru²⁺, Os⁸⁺, Os⁷⁺, Os⁶⁺, Os⁵⁺, Os⁴⁺, Os³⁺, Os²⁺, OS⁺, Os, Co⁵⁺, Co⁴⁺, Co³⁺, Co²⁺, Co⁺, Rh⁶⁺, Rh⁵⁺, Rh⁴⁺, Rh³⁺, Rh²⁺, Rh⁺, Ir⁶⁺, Ir⁵⁺, Ir⁴⁺, Ir³⁺, Ir²⁺, Ir⁺, Ir, Ni³⁺, Ni²⁺, Ni⁺, Ni, Pd⁶⁺, Pd⁴⁺, Pd²⁺, Pd⁺, Pd, Pt⁶⁺, Pt⁵⁺, Pt⁴⁺, Pt³⁺, Pt²⁺, Pt⁺, Cu⁴⁺, Cu³⁺, Cu²⁺, Cu⁺, Ag³⁺, Ag²⁺, Ag⁺, Au⁵⁺, Au⁴⁺, Au³⁺, Au²⁺, Au⁺, Zn²⁺, Zn⁺, Zn, Cd²⁺, Cd⁺, Hg⁴⁺, Hg²⁺, Hg⁺, B³⁺, B²⁺, B⁺, Al³⁺, Al²⁺, Al⁺, Ga³⁺, Ga²⁺, Ga⁺, In³⁺, In²⁺, In¹⁺, Tl³⁺, Tl⁺, Si⁴⁺, Si³⁺, Si²⁺, Si⁺, Ge⁴⁺, Ge³⁺, Ge²⁺, Ge⁺, Ge, Sn⁴⁺, Sn²⁺, Pb⁴⁺, Pb²⁺, As⁵⁺, As³⁺, As²⁺, As⁺, Sb⁵⁺, Sb³⁺, Bi⁵⁺, Bi³⁺, Te⁶⁺, Te⁵⁺, Te⁴⁺, Te²⁺, La³⁺, La²⁺, Ce⁴⁺, Ce³⁺, Ce²⁺, Pr⁴⁺, Pr³⁺, Pr²⁺, Nd³⁺, Nd²⁺, Sm³⁺, Sm²⁺, Eu³⁺, Eu²⁺, Gd³⁺, Gd²⁺, Gd⁺, Tb⁴⁺, Tb³⁺, Tb²⁺, Tb⁺, Db³⁺, Db²⁺, Ho³⁺, Er³⁺, Tm⁴⁺, Tm³⁺, Tm²⁺, Yb³⁺, Yb²⁺, Lu³⁺, La³⁺, La²⁺, La⁺, and combinations thereof, including any complexes which contain the metal ions listed, as well as any corresponding metal salt counter-anions.

10. The MOF of claim 9, wherein M is a metal ion selected from: Ti⁴⁺, Ti³⁺, Ti²⁺, Cr⁶⁺, Cr⁵⁺, Cr⁴⁺, Cr³⁺, Cr²⁺, Cr⁺, Al³⁺, Al²⁺, or Al⁺, including any complexes which contain the metal ions listed, as well as any corresponding metal salt counter-anions.

11. The MOF of claim 10, wherein M is a metal ion selected from: Al³⁺, Al²⁺, or Al⁺, including any complexes which contain the metal ions listed, as well as any corresponding metal salt counter-anions.

12. The MOF of claim 1, wherein the SBUs of the MOF comprise four pendant linkers.

13. The MOF of claim 12, wherein the four pendant linkers have the same structure as the organic linking moiety.

14. The MOF of claim 13, wherein the MOF comprises Al₈(OH)₈(BTB)₄(H₂BTB)₄ (MOF-519).

15. The MOF of claim 1, wherein the MOF comprises one of more modulators that have a structure selected from: formate, acetate, propionate, butyrate, pentanate, hexanate, lactate, oxalate, citrate, pivalate, carboxylate anions of amino acids, 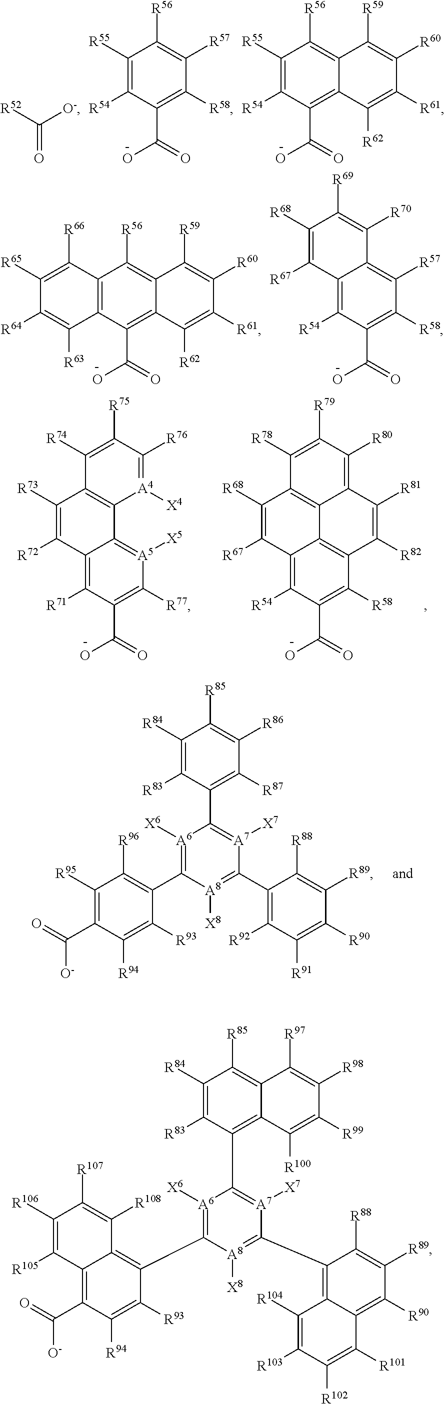
wherein,
A⁴-A⁸ are independently a C, N, O, or S;
X⁴-X⁸ are independently selected from H, D, optionally substituted FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more substituted rings selected from the group comprising cycloalkyl, cycloalkenyl, heterocycle, aryl, and mixed ring system; and
R⁵² and R⁵⁴-R¹⁰⁸ are independently selected from H, D, optionally substituted FG, optionally substituted (C₁-C₂₀)alkyl, optionally substituted (C₁-C₁₉)heteroalkyl, optionally substituted (C₁-C₂₀)alkenyl, optionally substituted (C₁-C₁₉)heteroalkenyl, optionally substituted (C₁-C₁₉)alkynyl, optionally substituted (C₁-C₁₉)heteroalkynyl, optionally substituted (C₁-C₁₉)cycloalkyl, optionally substituted (C₁-C₁₉)cycloalkenyl, optionally substituted aryl, optionally substituted heterocycle, optionally substituted mixed ring system, wherein one or more adjacent R groups can be linked together to form one or more substituted rings selected from the group comprising cycloalkyl, cycloalkenyl, heterocycle, aryl, and mixed ring system.

16. The MOF of claim 15, wherein the SBUs of the MOF comprise four modulators, and wherein the modulators are selected from formate, acetate, and pivalate.

17. The MOF of claim 16, wherein the MOF comprises Al₈(OH)₈(BTB)₄(HCOO)₄ (MOF-520).

18. The MOF of claim 1, wherein the SBUs of the MOF further comprise one or more bound organic molecules or metal clusters.

19. The MOF of claim 1, wherein the MOF has a methane working capacity of at least 190 cm³ cm⁻³ at 80 bar.

20. The MOF of claim 19, wherein the MOF has a methane working capacity of at least 230 cm³ cm⁻³ at 80 bar.

21. A gas storage or a gas separation device comprising a MOF of claim 1.

22. The gas storage device of claim 21, wherein the gas storage device is fuel storage tank.

23. The gas storage device of claim 22, wherein the tank is methane storage tank or a clean natural gas (CNG) tank.

24. The gas storage device of claim 23, wherein the methane storage tank or the CNG tank is dimensioned and configured to be used in a vehicle.

25. A method to separate and/or store one or more gases comprising contacting the one or more gases with the MOF of claim 1.

26. The method of claim 25, wherein the one or more gases comprise natural gas.

27. The method of claim 25, wherein the one or more gases comprise methane.
